(19) United States
(12) Patent Application Publication
(10) Pub. No.: US 2008/0215427 A1
(43) Pub. Date: Sep. 4, 2008

(54) PRODUCT INFORMATION PROVIDER SYSTEM AND METHOD

(76) Inventors: Yohei KAWADA, Yokohama (JP); Yoshihiro Mizuno, Yokohama (JP); Motonobu Saito, Kawasaki (JP); Takeshi Suzuki, Kawasaki (JP); Masafumi Uematsu, Fuchu (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/865,866

(22) Filed: Oct. 2, 2007

(30) Foreign Application Priority Data
Oct. 4, 2006 (JP) 2006-273281

(51) Int. Cl. G06Q 30/00

(52) U.S. Cl. 705/14

(57) ABSTRACT

A shelf reader reads a product unique ID of an IC tag attached to a product on a shelf. In accordance with the reading result, a shelf terminal detects whether the product is taken out from the shelf or not, and forwards the detection result to a product information management server together with the product unique ID. In the product information management server, a related product information extraction section refers to a related product information database, and extracts any related product information including the type of the product taken out from the shelf. This related product information indicates a combination of a plurality of products that are considered preferable to purchase together. An advertisement information creation section creates advertisement information based on thus extracted related product information. The resulting advertisement information is forwarded to the shelf terminal, and then is displayed by an output section of the shelf terminal.

### FIELD OF THE INVENTION

The present invention relates to a product information provider system and method that offer information about products through wireless communications with a wireless communications tag provided to each of the products.

### BACKGROUND OF THE INVENTION

In various types of fields, a wireless communications tag has been recently widely used. This wireless communications tag is equipped therein with a memory, and wireless communications with the wireless communications tag enables reading and writing of information from/to the memory.

As an example, Patent Document 1 (JP-A-2005-10608) describes a previous system of offering information about products through wireless communications with a wireless communication tag provided to each of the products.

The system of Patent Document 1 includes a tag information reader for reading information from a wireless communications tag provided to a product, and a display unit of displaying advertisement of the product. The tag information reader and the display unit are both disposed in the vicinity of a product shelf. When the tag information reader detects that the product is taken out, the display unit accordingly displays thereon any one of a plurality of advertisements prepared for the product.

### SUMMARY OF THE INVENTION

With such a previous technique, advertisement display is made for a product when a customer takes out the product, thereby being able to expect effects of encouraging the customer to buy the product. The problem here is that the concern of store managers or others lies in encouraging their customers to buy products as many as possible, and increasing sales of their stores.

Therefore, an object of the invention is to provide a product information provider system and method that can encourage customers to buy products as many as possible to meet demands of store managers and others.

To achieve such an object, a first aspect of the invention is directed to a product information provider system that offers information about a plurality of products through wireless communications with a wireless communication tag attached to each of the products and stored with an identifier assigned each of the products. The system includes: a reader that reads the identifiers of the products through wireless communications with the wireless communications tags attached to the products being disposed at a product space; event detection means for detecting whether any of the products is taken out from the product space in accordance with a reading result of the reader; related information storage means being stored with a plurality pieces of related product information each including a combination of a plurality of product types that are considered preferable to purchase together and/or advertise together; related information extraction means for extracting, when a take-out event is detected for any of the products by the event detection means, any of the related product information stored in the related information storage means including the product types for the product; advertisement information creation means for creating advertisement information for the product types found in the related product information extracted by the related information extraction means using previously-stored advertisement data; and advertisement output means for outputting the advertisement information created by the advertisement information creation means.

To achieve the above-described object, another aspect of the invention is directed to a product information provider system that offers information about a plurality of products through wireless communications with a wireless communication tag attached to each of the products and stored with an identifier assigned each of the products. The system includes: a reader that reads the identifier of any of the products being carried around on a shopping floor through wireless communications with the wireless communications tag attached to the product; event detection means for detecting a product type of the product being carried around in accordance with a reading result of the reader; related information storage means being stored with a plurality pieces of related product information each including a combination of a plurality of product types that are considered preferable to purchase together and/or advertise together; related information extraction means for extracting, when a carry-around event is detected for the product by the event detection means, any of the related product information stored in the related information storage means including the product type for the product; advertisement information creation means for creating advertisement information for the product types found in the related product information extracted by the related information extraction means using previously-stored advertisement data; and advertisement output means for outputting the advertisement information created by the advertisement information creation means.

Alternatively, in such product information provider systems, the advertisement information creation means may create the advertisement information including shopping-floor position information about at least one of the product types found in the related product information extracted by the related information extraction means using, as the previously-stored advertisement data, data indicating a position on a shopping floor of at least one of the product types not including the product type related to the event detected by the event detection means.

Still alternatively, such product information provider systems may each include: event information storage means for storing, with a correlation, the identifier of the product through with event detection by the event detection means and the related product information extracted by the related information extraction means in accordance with an event detection result for the product; a payment reader that reads, at a time of payment, the identifier of one or more of the products whatever purchased through wireless communications with the wireless communications tag(s) attached to the product(s); and advertisement information evaluation means for searching the identifiers stored in the event information storage means to find the identifier(s) of the product(s) read by the payment reader, extracting the related product information related to the identifier(s), comparing the product types found in the related product information and the product type of one or more of the identifiers read by the payment reader, and evaluating the advertisement information about the related product information using a predetermined evaluation technique.

With such a configuration, preferably, the product information product systems may each further include evaluation result storage means for storing a result of evaluating the advertisement information by the advertisement information evaluation means with a correlation to the related product information about the advertisement information. In the systems, also preferably, after the event detection for the product, at a time of extracting any of the related product information stored in the related information storage means including the product type of the product, when finding and extracting plurally the related product information including the product type, the related information extraction means may refer to the evaluation result storage means to extract, from the plurality pieces of extracted related product information, in order of high evaluation scores, the related product information as many as the advertisement information that is previously made ready for simultaneous output by the advertisement output means.

To achieve the above-described object, still another aspect of the invention is directed to a product information provider method of offering information about a plurality of products through wireless communications with a wireless communication tag attached to each of the products and stored with an identifier assigned each of the products. The method includes: a read step of reading, using a reader, the identifiers of the products through wireless communications with the wireless communications tags attached to the products being disposed at a product space; an event detection step of detecting whether any of the products is taken out from the product space in accordance with a reading result of the reader; a related information extraction step of extracting, when a take-out event is detected for any of the products in the event detection step, from a related information storage area storing therein a plurality pieces of related product information each including a combination of a plurality of product types that are considered preferable to purchase together and/or advertise together, any of the related product information including a product type of the product; an advertisement information creation step of creating advertisement information for the product types found in the related product information extracted in the related information extraction step using previously-stored advertisement data; and an advertisement output step of outputting the advertisement information created in the advertisement information creation step in the vicinity of a place where the take-out event is occurred.

To achieve the above-described object, still another aspect of the invention is directed to a product information provider method of offering information about a plurality of products through wireless communications with a wireless communication tag attached to each of the products and stored with an identifier assigned each of the products. The method includes: a read step of reading, using a reader, the identifier of any of the products being carried around on a shopping floor through wireless communications with the wireless communications tag attached to the product; an event detection step of detecting a product type of the product being carried around in accordance with a reading result of the reader; a related information extraction step of extracting, when a carry-around event is detected for the product in the event detection step, from a related information storage area storing therein a plurality pieces of related product information each including a combination of a plurality of product types that are considered preferable to purchase together and/or advertise together, any of the related product information including the product type of the product; an advertisement information creation step of creating advertisement information for the product types found in the related product information extracted in the related information extraction step using previously-stored advertisement data; and an advertisement output step of outputting, by output means, the advertisement information created in the advertisement information creation step in the vicinity of a place where the carry-around event is occurred.

Alternatively, in such product information provider methods, the advertisement information creation step may create the advertisement information including shopping-floor position information about at least one of the product types found in the related product information extracted in the related information extraction step using, as the previously-stored advertisement data, data indicating a position on a shopping floor of at least one of the product types not including the product type related to the event detected in the event detection step.

Still alternatively, such product information provider methods may each further include an event information storage step of storing, in an event information storage area, with a correlation, the identifier of the product through with event detection in the event detection step and the related product information extracted in the related information extraction step in accordance with an event detection result for the product; a payment reader that reads, using a payment reader, at a time of payment, the identifier of one or more of the products whatever purchased through wireless communications with the wireless communications tag(s) attached to the product (s); and an advertisement information evaluation step of searching the identifiers stored in the event information storage area to find the identifier(s) of the product(s) read by the payment reader, extracting the related product information related to the identifier(s), comparing the product types found in the related product information and the product type of one or more of the identifiers read by the payment reader, and evaluating the advertisement information about the related product information using a predetermined evaluation technique.

In such a case, the product information provider methods may each further include an evaluation result storage step of storing, in an evaluation result storage area, a result of evaluating the advertisement information in the advertisement information evaluation step with a correlation to the related product information about the advertisement information. In the methods, preferably, after the event detection for the product, at a time of extracting any of the related product information stored in the related information storage area including the product type of the product, when finding and extracting plurally the related product information including the product type, the related information extraction step refers to the evaluation result storage area to extract, from the plurality pieces of extracted related product information, in order of high evaluation scores, the related product information as many as the advertisement information that is previously made ready for simultaneous output in the advertisement output step.

According to the aspects of the invention, customers are provided with advertisement information about a plurality of related products including a product type(s) read by the reader, thereby successfully encouraging the customers to buy products as many as possible. Especially with a function of evaluating the advertisement information, the evaluation result is used as a basis to change the advertisement information, in other words, change details of a plurality of related information so that advertisement can be made for a plurality of products with good efficiency.

### BRIEF DESCRIPTION OF THE DRAWINGS

FIG. 1 is an external view of a product information provider system of embodiments of the invention, showing the entire configuration thereof;

FIG. 2 is a diagram showing the entire configuration of a product information provider system in the first embodiment of the invention;

FIG. 3 is a diagram showing the data configuration of a product information database (DB) in the first embodiment of the invention;

FIG. 4 is a diagram showing the data configuration of an event information DB in the first embodiment of the invention;

FIG. 5 is a diagram showing the data configuration of an advertisement evaluation log DB in the first embodiment of the invention;

FIG. 6 is a flowchart of an operation at the time of event detection in the product information provider system in the embodiments of the invention;

FIG. 7 is a flowchart of a detailed operation in step 500 of FIG. 6;

FIG. 8 is a flowchart of an operation at the time of advertisement information evaluation in the product information provider system in the embodiments of the invention;

FIG. 9 is a diagram for illustrating an evaluation point provision policy in the embodiments of the invention;

FIG. 10 is a diagram for illustrating an exemplary advertisement information screen in the first embodiment of the invention;

FIG. 11 is a diagram showing the entire configuration of a product information provider system in a second embodiment of the invention;

FIG. 12 is a flowchart of a detailed operation in step 600 of FIG. 6;

FIGS. 13A and 13B are each a diagram for specifically illustrating the flowchart of FIG. 12, i.e., FIG. 13A shows a case where products selected by a customer are the same as those in related product information; and FIG. 13B shows a case where products selected by a customer are not the same as those in related product information;

FIG. 14 is a diagram showing the data configuration of an event information DB in the second embodiment of the invention;

FIG. 15 is a flowchart of a detailed operation in step 610 of FIG. 12;

FIG. 16 is a diagram showing an exemplary advertisement information screen in the second embodiment of the invention; and

FIG. 17 is a diagram showing the entire configuration of a product information provider system in a third embodiment of the invention.

### DESCRIPTION OF THE PREFERRED EMBODIMENTS

In the below, embodiments of the invention are described by referring to the accompanying drawings.

### First Embodiment

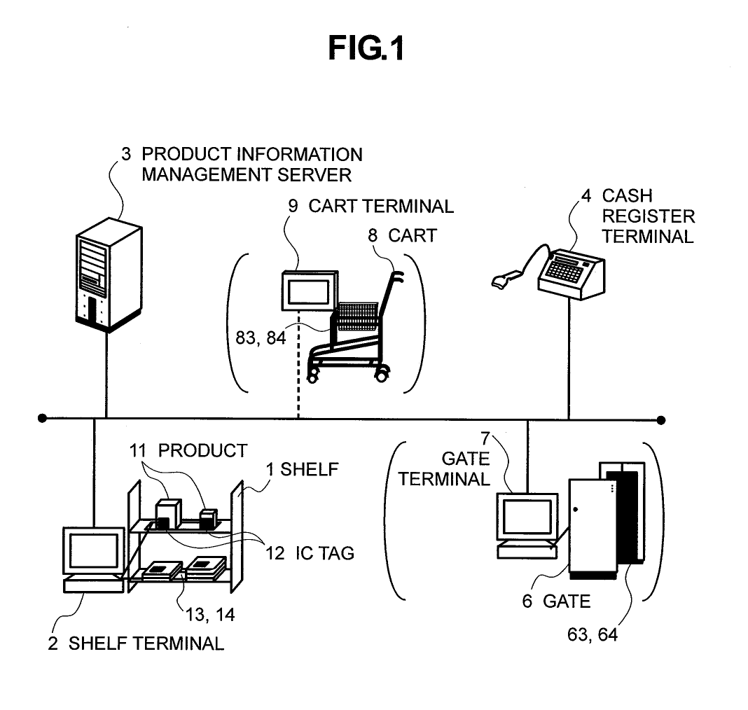

FIG. 1 is a diagram showing the entire configuration of a product information provider system in a first embodiment of the invention. Note that bracketed components in FIG. 1 are not described herein as are those for another embodiment that will be described later.

The product information provider system in this embodiment is configured to include a shelf terminal 2, a product information management server 3, and a cash register terminal 4. The shelf terminal 2 is disposed in the vicinity of a shelf 1 for products, and the cash register terminal 4 is disposed at a place for payment. The product information management server 3 manages information about the products varying in type. The components, i.e., the shelf 1, the shelf terminal 2, and the cash register terminal 4, are all disposed inside of a store, and the product information management server 3 is disposed in a room for staff, for example. These components are connected together over a network such as infrastructure network or by radio. Note that, in the below, exemplified is a case where the system is used in an apparel store.

On the shelf 1, a plurality of products 11 are disposed, and each of the products 11 is attached with an IC (Integrated Circuit) tag 12. This ID tag is configured to include a memory at least stored with a product unique ID (Identifier), an antenna for wireless communications with the outside, a transmission/reception control section for transmission and reception to/from the outside using the antenna, and a processing section in charge of data writing or reading to/from the memory, for example. To the shelf 1 or in the vicinity thereof, a shelf reader 14 is provided together with an antenna 13 for wireless communications with the IC tag 12 attached to each of the products.

The components, i.e., the shelf terminal 2, the product information management server 3, and the cash register terminal 4, are each configured by a computer equipped with network capabilities for communications. The computer is configured to include a CPU (Central Processing Unit) in charge of processing, and a memory for use with processing in the CPU. The memory is stored in advance with a program for implementing the functions of the above-described components 2, 3, and 4, and various types of data.

The shelf 1 is used for sale display of the products 11 in the store. FIG. 1 shows a piece of shelf 1 but surely the shelf 1 can be plurally provided. The shelf 1 is carrying thereon a plurality of products 11, each of which is attached with the above-described IC tag 12.

The shelf terminal 2 detects which of the products 11 is taken out from the shelf 1 or put back thereto by the shelf reader 14 being driven at regular intervals, and by reading of the product unique IDs is performed from the IC tags 12 attached to the products 11. When the unique ID of the product 11 that has been available for reading becomes not available, the shelf terminal 2 determines that the product 1 is taken out. On the other hand, when the unique ID of the product 11 that has not been available for reading becomes available, the shelf terminal 2 determines that the product 1 is put back to the shelf 1. Such detection made for the product, i.e., taken-out or put-back, is referred below to as “an event has occurred on the shelf 1”. The shelf terminal 2 processes the result of data reading made from the IC tag 12 by the shelf reader 14, and forwards the processing result to the product information management server 3. In response thereto, when advertisement information that will be described later comes in return from the product information management sever 3, the advertisement information is displayed on the display of the shelf terminal 2.

The product information management server 3 receives the processed reading result provided by the shelf terminal 2, and responsively searches a database for any appropriate related product information. When found, the product information management server 3 then forwards advertisement information corresponding to the found related product information to the shelf terminal 2. At the same time, the received reading result is stored in the database.

Note here that the related product information is about a combination of a plurality of products, which are recommended for purchasing all at once. If with an example of clothing, the combination includes a shirt and a tie, a blouse and a skirt, or any recommended coordination collectively including a suit, a tie, a shirt, a belt, shoes, a bag, and others. As such, when a customer takes out any one of the products 11 from the shelf 1, the shelf terminal 2 accordingly displays on its display information about any recommended products that will go well with the taken-out product 11, i.e., advertisement information based on the related product information. This favorably encourages the customer to make purchase, and suggests him or her to buy any other products together.

As will be described later, the cash register terminal 4 is connected with a cash register reader equipped with an antenna. When the customer makes a payment for the product 11, at the same time, the cash register terminal 4 reads the product unique ID of the product 11 from the IC tag 12 attached to the purchased product 11. When an IC-chip-attached membership card or others is issued for any customers registered as members, and when the customer presents his or her membership card at the time of payment, the cash register terminal 4 performs reading of the membership card together with reading of the IC tag 12 of the product 11. The cash register terminal 4 forwards the result of reading as such to the product information management server 3. Such reading of the IC tag 12 of the product 11 by the cash register terminal 4 is hereinafter referred to as “a purchase event has occurred in the cash register terminal 4”. In the below, the events described above, i.e., the take-out/put-back event, and the purchase event, are collectively referred to as event, or the respective events are simply referred to as event.

Note here that the product information management server 3 may be not restrictively disposed in a store, and alternatively, may be disposed at any other isolated places. The components, i.e., the shelf terminal 2, the product information management server 3, and the cash register terminal 4, may be all the same terminal. In the above, the shelf terminal 2 makes the shelf reader 14 perform reading of the IC tag 12, and displays the advertisement information by forwarding the result of reading to the product information management server 3. Alternatively, these operations may be taken charge by each different component.

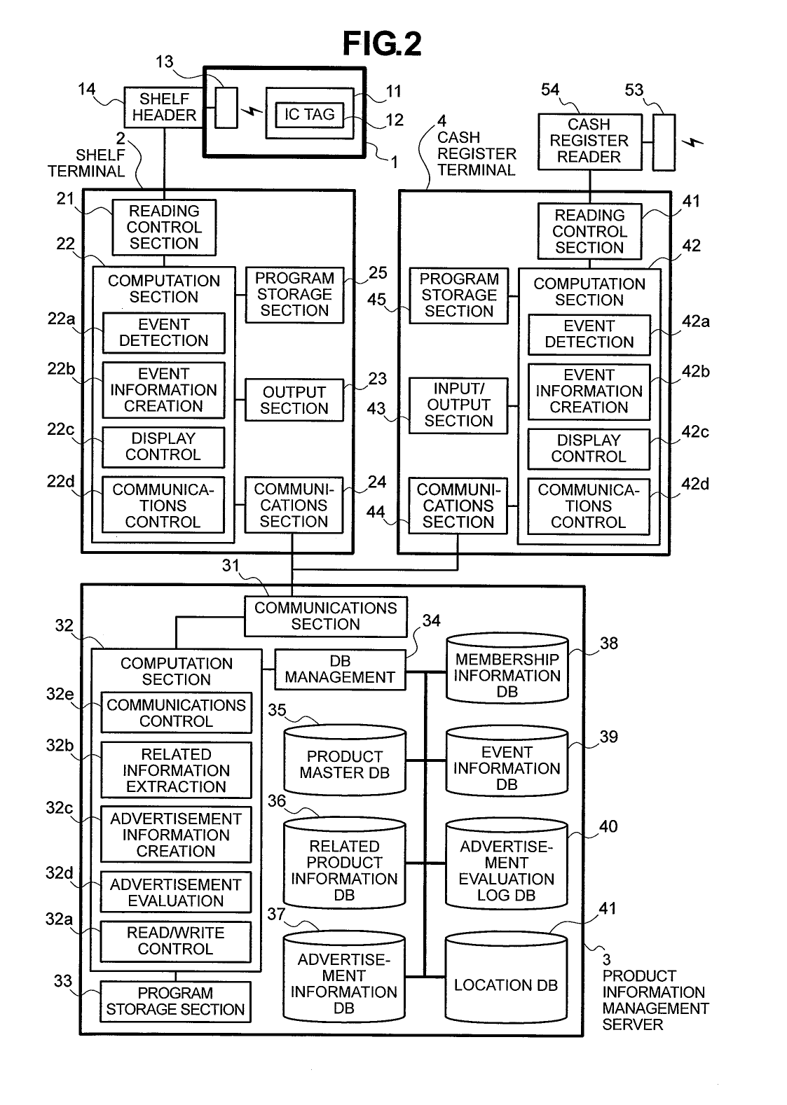

FIG. 2 is a diagram showing the configurations of the components, i.e., the shelf terminal 2, the product information management server 3, and the cash register terminal 4, configuring the product information provider system described above by referring to FIG. 1.

The shelf terminal 2 is configured to include a reader control section 21, a computation section 22, a communications section 24, an output section 23, and a program storage section 25. The reader control section 21 controls the driving of the shelf reader 14. The computation section 22 applies predetermined processing to information read by the shelf reader 14. The communications section 24 communicates with the product management server 3. The output section 23 displays thereon advertisement information coming from the product management server 3. The program storage section 25 is storing therein a program to be run by the computation section 22. The computation section 22 is configured to include an event detection section 22a, an event information creation section 22b, a display control section 22c, and a communications control section 22d. The event detection section 22a detects whether an event has occurred, i.e., a take-out event or a put-back event, based on the reading result derived by the shelf reader 14. The event information creation section 22b creates event information in accordance with the event detected by the event detection section 22a. The display control section 22c controls display by the output section 23, and the communications control section 22d controls the communications section 24. The computation section 22 runs the program stored in the program storage section 25 so that the functions of the components 22a to 22d are implemented.

As described above, the cash register terminal 4 is connected with a cash register reader 54 equipped with an antenna 53. This cash register terminal 4 is configured to include a reader control section 41, a computation section 42, an input/output section 43, a communications section 44, and a program storage section 45. The reader control section 41 controls the driving of the cash register reader 54, and the computation section 42 applies any predetermined processing to information being the reading result of the cash register reader 54. The input/output section 43 displays thereon any predetermined information, and receives any predetermined information. The communications section 44 communicates with the product management server 3, and the program storage section 45 is stored with a program to be run by the computation section 42. The computation section 42 is configured to include an event detection section 42a, an event information creation section 42b, an input/output control section 42c, and a communications control section 42d. The event detection section 42a detects whether a purchase event has occurred based on the reading result derived by the cash register reader 54. The event information creation section 42b creates event information in accordance with the event detected by the event detection section 42a. The input/output control section 42c controls input and output in the output section 43, and the communications control section 42d controls the communications section 44. The computation section 42 runs the program stored in the program storage section 45 so that the functions of the components 42a to 42d are implemented. The input/output section 43 displays thereon information read by the cash register reader 54, e.g., the number of the products 11. If required, this input/output section 43 is provided with a button for checking the number of products.

The product information management server 3 is configured to include a communications section 31, a computation section 32, a program storage section 33, various types of databases 35 to 41, and a database management section 34. The communications section 31 is provided for communications with the terminals 1 and 4, and the computation section 32 applies any predetermined processing to information received by the communications section 31. The program storage section 33 is stored with a program to be run by the computation section 34, data, and others. The database management section 34 manages the databases 35 to 41 varying in type.

The databases 35 to 41 include the product master database 35 stored with basic information about the products 11. The related product information database 36 is stored with related product information that includes a combination of a plurality of products that are considered preferable to purchase together. The advertisement information database 37 is stored with advertisement information, which includes information about the combination of a plurality of products indicated by the related product information. The member information database 38 is stored with information about members, e.g., membership numbers and names. The event information database 39 is stored with event information provided by the terminals 2 and 4. An advertisement evaluation log database 40 is stored with a result of evaluating the advertisement information corresponding to the related product information. The location database 41 is stored with information about the locations of the products in the store on a product type basis or for every antenna.

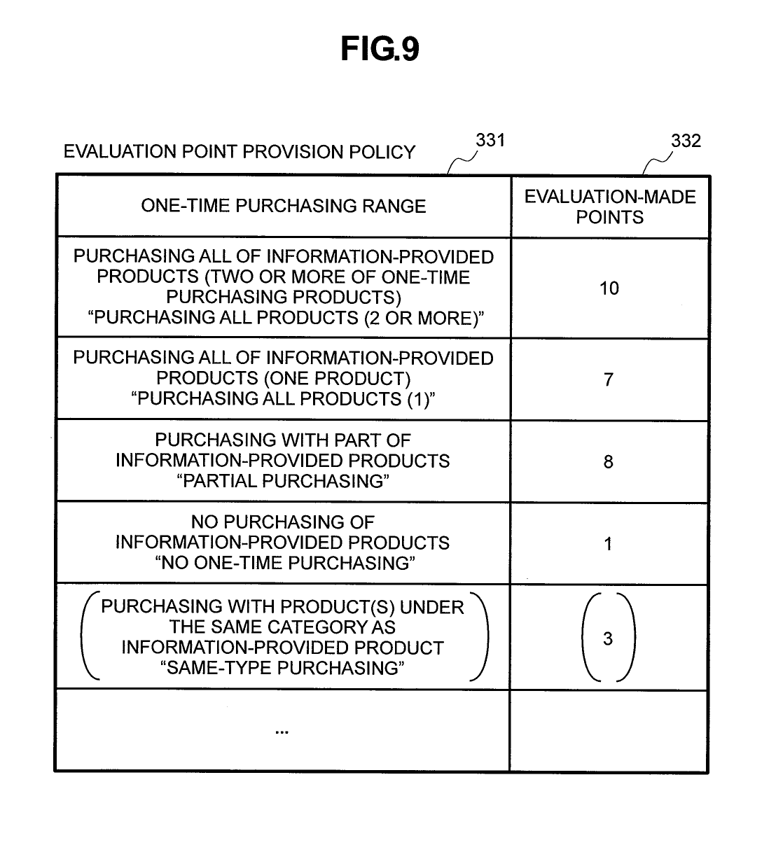

The computation section 32 is configured to include a read/write control section 32a, a related information extraction section 32b, an advertisement information creation section 32c, an advertisement evaluation section 32d, and a communications control section 32e. The read/write control section 32a performs data writing to the databases 35 to 41, and data reading from the databases 35 to 40 via the database management section 34. The related information extraction section 32b extracts any predetermined related information from the related product information database 36. The advertisement information creation section 32c creates advertisement information corresponding to the related product information. The advertisement evaluation section 32d evaluates the advertisement information corresponding to the related information. The communications control section 32e controls the communications section 31. The computation section 32 runs the program stored in the program storage section 33 so that the functions of the components 32a to 32e are implemented. The program storage section 33 is also stored with an evaluation point provision policy (FIG. 9) for use to evaluate the advertisement information.

Next, the databases 35 to 41 are described in detail.

As described above, the product master database 35 retains therein basic information about the products 11 in the store. This product master database 35 is stored with, for every product code indicating a product type, information about the product name, the price, and the product category (e.g., shirt, tie, or skirt). The product master database 35 is also stored with color information if the products 11 are the clothes, product codes of any products similar in product type to those under the product codes, and information about what product type a product unique ID is indicating, i.e., mapping information between product unique IDs and product codes. This mapping information enables to define the products 11 by product type using the product unique IDs coming from the shelf terminal 2 and the cash register terminal 4. Note here that this mapping information is not necessarily used when product codes are provided by the shelf terminal 2 and the cash register terminal 4 together with the product unique IDs, or when the format of the product unique ID indicates the product type.

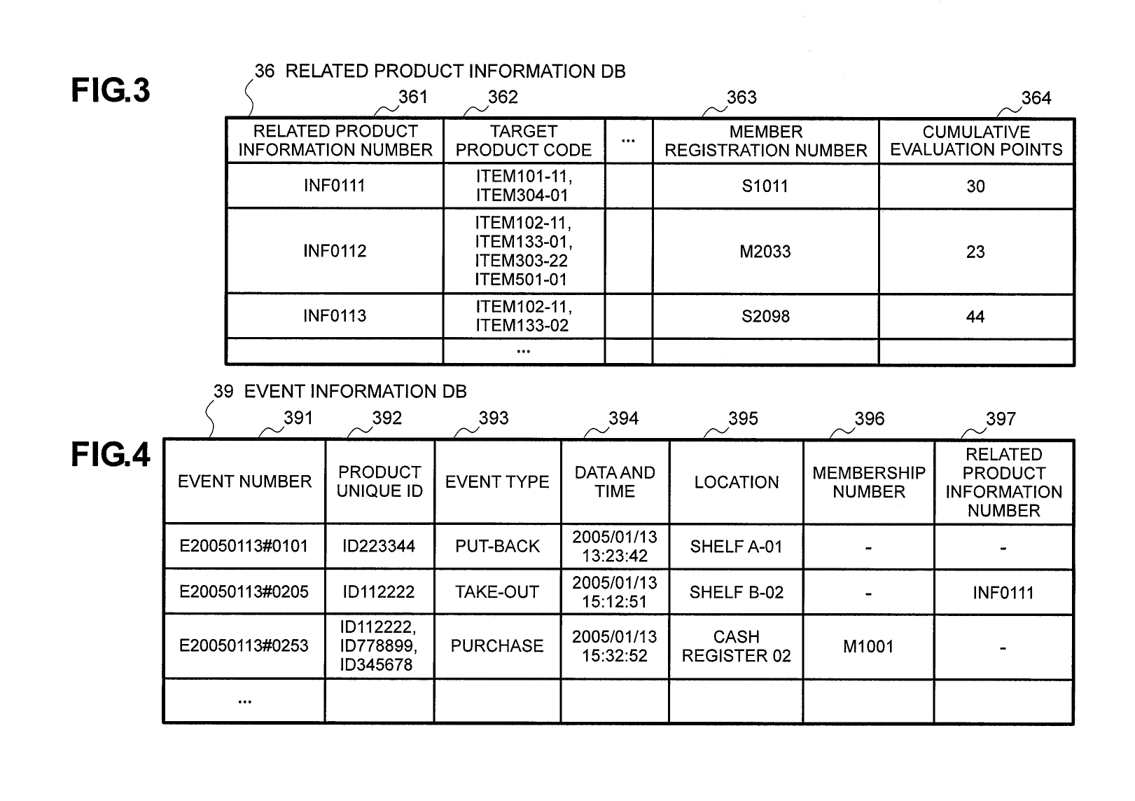

As described above, the related product information database 36 is stored with related product information, which is the basis of the advertisement information to be displayed on the output section 23 of the shelf terminal 2. As shown in FIG. 3, this related product information database 36 includes a related product information field 361, a target product code field 362, a member registration number field 363, and a cumulative evaluation point field 364. The related product information field 361 is stored with a related product information number assigned each related product information. The target product code field 362 is stored with a plurality of target product codes each representing the target product type of any recommended combination. The member registration number field 363 is stored with a registration number provided for a person whose related product information has been registered. The cumulative evaluation point field 364 is stored with a value of a cumulative evaluation point that represents the result of evaluating advertisement information corresponding to the related product information. The target product code field 362 is stored with product codes of two or more of the products in a recommended combination of products. The member registration number field 363 shows an employee number or others when the related product information is registered by an employee of the store, and shows a membership number or others when registered is the related product information created based on purchasing history information or others of a member. The details about the cumulative evaluation point to be stored into the cumulative evaluation point field 364 will be described later.

The advertisement information database 37 is stored with image data for each of a plurality of related product information numbers. The image data here is the one needed for creating advertisement information. To be specific, the advertisement information database 37 is stored with image data or others indicating a coordination of products found in the related product information.

The member information database 38 is stored with a membership number of a customer being a store member, his or her attribute information, e.g., name, address, age, sex, occupation, and his or her favorite fashion style, and actual purchasing record. The member information database 38 is also stored with relative information between a membership number and a unique ID in an IC chip in a membership card.

The event information database 39 is stored with event information coming from the shelf terminal 2 and event information coming from the cash register terminal 4. As shown in FIG. 4, this event information database 39 is configured to include an event number field 391, a product unique ID field 392, an event type field 393, a date and time field 394, a location field 395, a membership number field 396, and a related product information number field 397. The event number field 391 is stored with an event number assigned each event information, and the product unique ID field 392 is stored with a unique ID of a product being an event target. The event type field 393 is stored with event type, i.e., take-out, put-back, and purchase, and the date and time field 394 is stored with a date and time when the event is detected. The location field 395 is stored with the location of an antenna that detected the event, and the membership number field 396 is stored with a membership number of a customer being the cause of the event occurrence. The related product information number field 397 is stored with a number of related product information corresponding to advertisement information whatever displayed after the event detection. Among these fields of the event information database 39, the fields 391 to 396 are each stored with data found in the event information coming from the shelf terminal 2 or the event information coming from the cash register terminal 4.

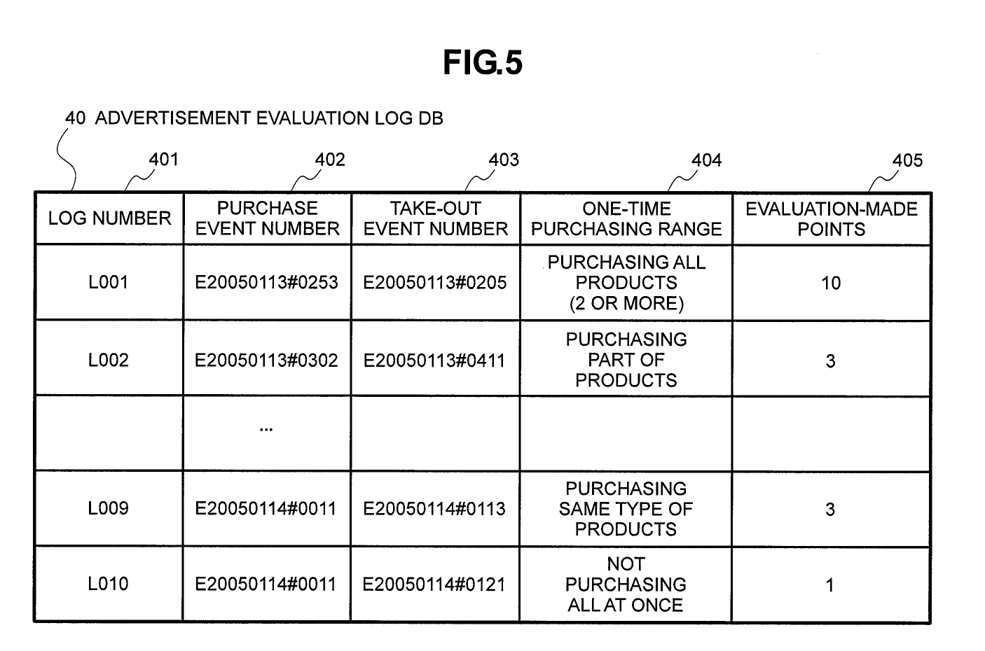

As described above, the advertisement evaluation log database 40 is stored with a result of evaluating advertisement information corresponding to the related product information. As shown in FIG. 5, the advertisement evaluation log database 40 is configured to include a log number field 401, a purchase event information number field 402, a take-out event number field 403, a one-time purchasing range field 404, and an evaluation-made point field 405. The log number field 401 is stored with a log number assigned each evaluation log, and the purchase event information number field 402 is stored with an information number of a purchase event. The take-out event number field 403 is stored with an information number of a take-out event being the cause of the occurrence of the purchase event. The one-time purchasing range field 404 is stored with a one-time purchasing range indicating how many and what products are purchased, and the evaluation-made point field 405 is stored with a value of the evaluation point for the advertisement information displayed at the time of take-out event.

As described above, the location database 41 is stored with in-store location information for every product type and for every antenna. This location database 41 is stored with a location number, a product code or an antenna ID defined by location by the location information under the location number, and image data being an in-store map and indicating the locations where the product types and the antennas are found. As to the antenna IDs, the location database 41 also includes information about antenna IDs indicating the specific locations of the antenna, e.g., provided to the shelf 1 or to the cash register terminal 4.

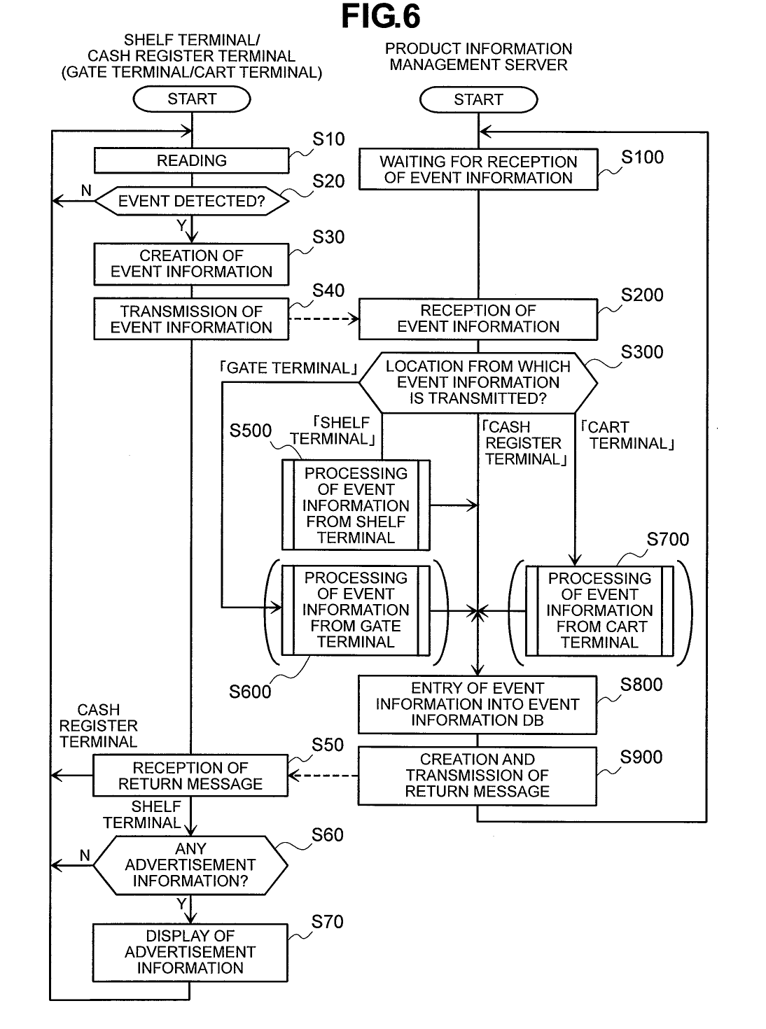

By referring to the flowcharts of FIGS. 6 to 8, described next is the operation of the product information provider system of this embodiment. Note that, in FIG. 6, bracketed steps are those for another embodiment that will be described below, and thus are not described herein.

As shown in the flowchart of FIG. 6, the reader control section 21 or 41 of the shelf terminal 2 or the cash register terminal 4 drives the reader 14 or 54 so as to read a unique ID of the product 11 from the IC tag 12 attached to the product 11 (S10). At the time of reading as such, the reader control section 21 of the shelf terminal 2 drives the shelf reader 14 at regular intervals, and makes the shelf reader 14 read the product unique ID from the IC tag 12 at regular intervals. The reader control section 41 of the cash register terminal 4 continuously drives the cash register reader 54, and makes the cash register reader 54 read the product unique ID from the IC tag 12 at any arbitrary timing, and in some cases, read a membership number or others from a membership card.

The event detection section 22a or 44a of the shelf terminal 2 or the cash register terminal 4 detects any occurrence of an event in accordance with a reading result of the reader 14 or 54 (S20). As described in the foregoing, the event detection section 22a of the shelf terminal 2 acknowledges that a take-out event of the product 11 is occurred when the product unique ID that has been available for reading becomes not available. When the product unique ID that has been not available for reading becomes available, the event detection section 22a acknowledges that a put-back event of the product 11 is occurred. When the product unique ID is read, the event detection section 44a of the cash register terminal 4 acknowledges that the product 11 of the ID is purchased, i.e., a purchase event is occurred. When the event detection section 22a or 44a of the shelf terminal 2 or the cash register terminal 4 is not able to detect any occurrence of an event, the system is put in the standby state, and the procedure returns to step 10.

When the occurrence of an event is detected, the event information creation section 22b or 44b of the shelf terminal 2 or the cash register terminal 4 creates event information (S30). This event information includes an event number, a product unique ID being a reading result, an event type (take-out, put-back, or purchase), date and time when the event has occurred, and the location of the event occurrence. The event information creation section 22b and 44b create an event number every time an event occurs, and generate location based on the ID of the antennas 13 and 46. The event information creation sections 22b and 42b acquire the event information, i.e., the product unique ID, the event type, and the date and time when the event has occurred, from the event detection sections 22a and 42a, respectively. When any membership number is read in step S10, the event information generation section 42b of the cash register terminal 4 creates the event information also including this membership number. When the cash register reader 54 of the cash register terminal 4 reads a product unique ID from a plurality of IC tags 12 all at once, the event information generation section 42b of the cash register terminal 4 determines that a plurality of products 11 are purchased at the same time by one purchase event. That is, the event information generation section 42b of the cash register terminal 4 creates the event information also including the unique IDs of the products 11 that are purchased at the same time. When any two different events are detected at the same time, i.e., a take-out event and a put-back event are detected at the same time, the event information generation section 22b of the shelf terminal 2 creates the event information for each of the events.

With such generation of event information, in the event information database 39 of FIG. 4, data is generated for storage into the fields but not the related product information number field 397, i.e., the fields 391 to 396.

After the event information is generated as such, the event information is converted into any predetermined format of communications data by the communications control section 22d or 42d of the shelf terminal 2 or the cash register terminal 4, and the result is forwarded from the communications section 24 to 44 to the product information management server 3 (S40).

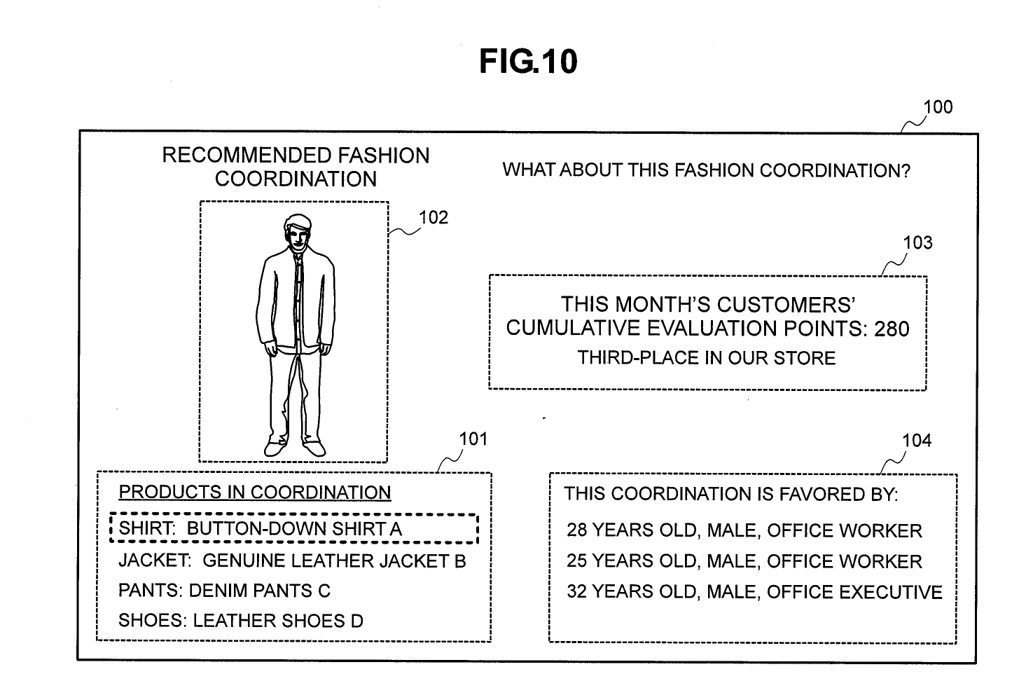

After the event information is sent to the product information management server 3, the shelf terminal 2 and the cash register terminal 4 are put into the waiting state for a return message from the product information management server 3. In the case with the shelf terminal 2, when receiving a return message (S50), the communications control section 22d determines whether the return message is including advertisement information. When advertisement information is not found, the procedure returns to step S10, and when any advertisement information is found, this advertisement information is forwarded to the display control section 22c for display on the output section 23 as shown in FIG. 10 (S60). After the advertisement information is displayed as such, the procedure returns to step S10. In the case with the cash register terminal 4, when a return message is received (S50), the procedure returns to step S10.

On the other hand, when the product information management server 3 is in the state of waiting for event information (S100), if event information comes from the shelf terminal 2 or the cash register terminal 4, the event information is accordingly received (S200). The product information management server 3 then analyzes the location found in the event information, and determines from which terminal 2 or 4 the event information is provided (S300). Considered now is a case where event information is including no location but an ID of an antenna receiving data for use to create the event information. In this case, the location database 41 (FIG. 2) indicating the locations on an antenna ID basis may be made ready in advance to make the locations available from the antenna IDs, and by reference thereof, the location may be acquired from the antenna ID found in the event information.

When the event information is the one coming from the cash register terminal 4, the procedure goes to step S800, which will be described later, and when the event information is the one coming from the shelf terminal 2, the product information management server 3 processes the event information in a manner as will be described later (S500) before the procedure goes to step 800. In step 800, the read/write control section 32a of the product information management server 3 makes the database management section 34 write the event information into the event information database 39. That is, in the event information database 39 of FIG. 4, the event number field 391 is stored with an event number, the product unique ID field 392 is stored with a product unique ID, the event type field 393 is stored with an event type (take-out, put-back, or purchase), the date and time field 394 is stored with the date and time when the event has occurred, the location field 395 is stored with a location, the membership number field 396 is stored with a membership number, and the related product information number field 397 is stored with a related product information number. Note here that, among the data to be stored into the fields as such, the related product information number is not the one found in the event information but the one to be derived as a result of the processing in step 500. Moreover, the event numbers used in this example are those to be created by the terminals 2 and 4. Alternatively, the product information management server 3 may create such event numbers, and if this is the case, the events detected by the terminals 2 and 4 may be assigned numbers in order of event occurrence.

After registration of the event information (S800), the communications control section 32e of the product information management server 3 creates a return message, and makes the communications section 31 forward the return message to the terminal being the sender of the event information (S900). At this time, when any advertisement information is creased as a result of the processing in step 500, this advertisement information is included in the return message.

After transmission of the return message as such, the procedure returns to step 100 again, and the product information management server 3 is put into the state of waiting for event information to receive.

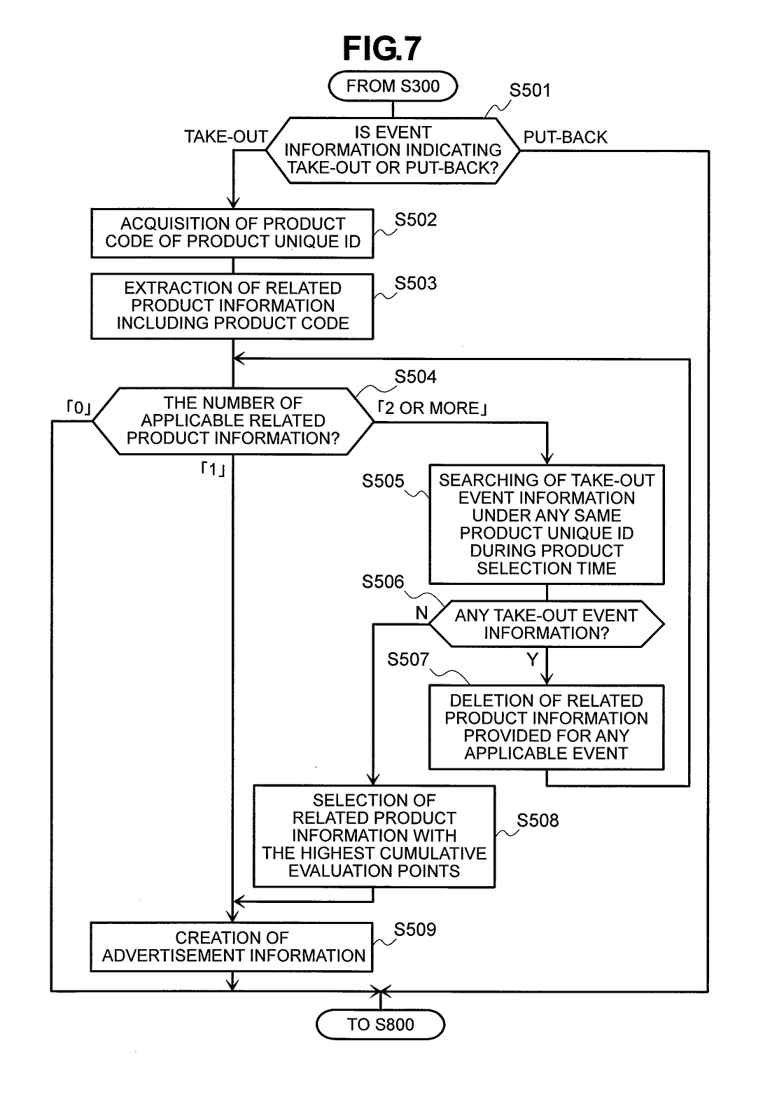

By referring to the flowchart of FIG. 7, described in detail is the processing (S500) to be performed by the product information management server 3 with respect to event information coming from the shelf terminal 2.

First of all, the related product information extraction section 32b of the product information management server 3 analyzes the event information provided by the shelf terminal 2, and determines the event type found in the event information, i.e., whether “take-out” or “put-back” (S501). When the event type is “take-out”, the procedure goes to step S502, and when the event type is “put-back”, this event information processing (S500) is immediately ended.

When the event type is “take-out”, the related product information extraction section 32b refers to the product master database 35, and acquires a product code corresponding to the product unique ID found in the event information (S502). Thereafter, the related product information extraction section 32b refers to the related product information database 36, and extracts the related product information including the product code (S503). The related product information extraction section 32b then determines the number of the related product information including the product code, i.e., whether the number is 0, 1, or 2 or larger (S504). In FIG. 3 example, in the related product information database 36, there are two related product information including the product code of ITEM 101-11, i.e., INF011 and INF0013. This means that, when the product under the product code of ITEM101-11 is a blue bottom-down shirt, for example, there are two types of tie or others going well with the shirt, i.e., there are two types of recommended coordination styles.

When the related product information is 0, i.e., when no related product information is extracted, this event information processing (S500) is ended, and the procedure goes to the above-described step 800. When the related product information is 1, the advertisement information creation section 32c creates advertisement information based on this related information (S509). This is the end of the event information processing (S500), and the procedure goes to the above-described step 800. When the related product information is 2 or larger, the related product information extraction section 32b searches the event information database 39 to see whether a take-out event under any same product unique ID has occurred within a time back by a predetermined product selection time (S505). This product selection time is set considering a customer's doings in terms of time, e.g., a customer comes in front of a specific shelf 1, selects any product 11, takes out the product 11 from the shelf 1, and then comes again in front of the same shelf 1, and takes out the same product 11. Such a product selection time is stored in advance in the program storage section 33. By searching the event information database 39 as such, the related product information extraction section 32b determines whether a take-out event under any same product unique ID has occurred (S506). When the determination result tells that no such take-out event has occurred under the same product unique ID, the related product information extraction section 32b selects any of the plurality of pieces of related product information showing the highest value of the cumulative evaluation point (stored in the related product information database 36) (S509). After the related product information is selected as such, as described above, the advertisement information creation section 32c creates advertisement information based on the resulting related information (S509). When the determination result tells that a take-out event under the same product unique ID has occurred, the related product information extraction section 32b deletes the related product information used by this take-out event from those others extracted in the above-described step 503 (S507). The procedure then returns to step 504.

The reason of deleting the related product information used for the previous take-out event from other related product information being the extraction results in the above-described step 503 is not to display the same advertisement information to the same customer, i.e., the advertisement information based on the related product information when the customer takes out the product 11. This is arranged considering a possible case that the customer may take out the product 11 from the shelf 1, put back the product 11, and then take out again the product from the shelf 1.

Described briefly now is processing in step 509, i.e., the advertisement information creation section 32c creates advertisement information.

The advertisement information creation section 32c creates advertisement information by writing any necessary information into an advertisement screen template, which is made ready in advance. In an exemplary case with advertisement information 100 of FIG. 10, the advertisement information creation section 32c refers to product master database 35, and acquires a product name for each of a plurality of product codes found in the related product information. Thus acquired product names are written into a box of products in coordination 101 in the advertisement screen template. At this time, if any of the products has been already taken out from the shelf 1 by the customer, the product is preferably displayed with an easy distinction from the remaining products. The advertisement information creation section 32c acquires image data for any corresponding related product information number from the advertisement information database 37, i.e., in this example, image data of a person dressed in the recommended clothing of any related products. The image data is then written into a box for a coordination image 102 in the advertisement screen template. Whenever required, a promotion sentence including a value of the cumulative evaluation point for a month is written into a box for evaluation point 103 in the advertisement screen template. The cumulative evaluation point is the one provided for advertisement information based on the related product information, i.e., for an exemplary coordination displayed by the advertisement information. The advertisement information creation section 32c identifies, on a product basis, any member who has purchased the product (s) found in the related product information by referring to the member information database 38, and writes the attribute of the member into a box for a coordinate favored crowd 104 in the advertisement screen template.

Note that, in this example, the advertisement information creation section 32c collects various types of data from the databases varying in type, and combines the data for creating advertisement information. Alternatively, for creating advertisement information including only product names in coordination and a coordination image, advertisement information including only the product names in coordination and the coordination image may be entered in the advertisement information database 37 with a correlation to a related product information number, thereby calling up advertisement information under the corresponding related product information number from the advertisement information database 37.

As described above, when the location database 41 carries therein location information on a product type basis, the advertisement information creation section 32c may create advertisement information including location information for every product type found in the related product information, e.g., map image data indicating the in-store positions of products. If this is the case, it is preferable to display location information about products not including product(s) already taken out by the customer from the shelf 1.

In the event information processing (S500) described above, in step 505, a search is made for a take-out event under any same product unique ID during a product selection time. Alternatively, a take-out event may be searched not by the product unique ID but by the product code. With this being the case, the event information database 39 may be provided with a field for storage of product codes, and for entry of event information, a product code of the product 11 caused an event to occur may be entered. With a search of a take-out event under any same product code as such, advertisement information to be displayed to a customer can be different even if the customer takes out two products at different times, i.e., the two products being different but under the same product type.

In the above example, a take-out event has a one-to-one relationship with advertisement information, but alternatively, a plurality pieces of advertisement information may be provided with respect to a take-out event. That is, when the related product information is plurally extracted in step 503, advertisement information corresponding to each of the relative product information may be plurally provided at the same time. If this is the case, in step 504, when the number of the related information extracted in step 503 is the same as the predetermined number of displaying advertisement information, the procedure immediately goes to step 509. On the other hand, when the number of the related information extracted in step 503 is larger than the predetermined number of displaying advertisement information, the procedure goes to step 505. In step 508, from a plurality of related product information, a selection is made as many as the number of the displaying advertisement information in a descending order of the values of the cumulative evaluation point.

In the above example, in step 504, when the applicable related product information is 0, the event information processing (S500) is ended without creating advertisement information. Alternatively, a product code of any product similar to the product under the product code acquired in step 502 is acquired with reference to the product master database 35, and with respect to the product code, the processing of step 503 may be performed.

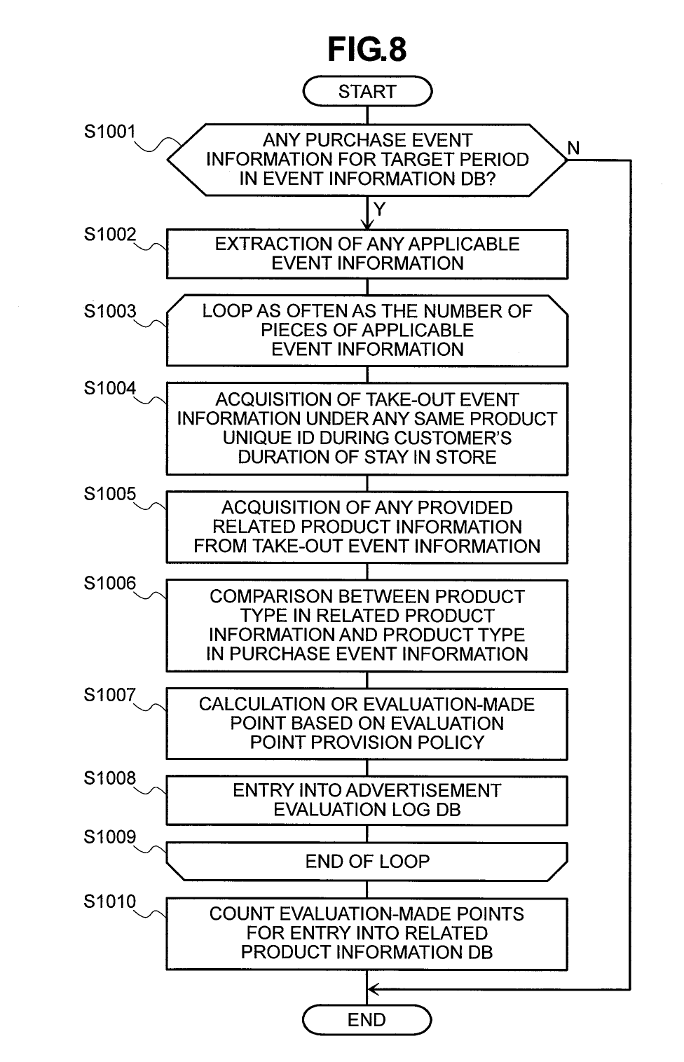

By referring to the flowchart of FIG. 8, described next is processing of evaluating advertisement information by the advertisement evaluation section 32d of the product information management server 3. Note here that the advertisement evaluation section 32d may perform this advertisement information evaluation processing every time a purchase event is occurred, and in this example, the processing is performed every predetermined period, e.g., every after business hours.

The advertisement evaluation section 32d searches the event information database 39 for a purchase event in a target period, i.e., events occurred during a day today (S1001). When no purchase event is found, this advertisement information evaluation processing is ended, and when there is any applicable purchase event, the advertisement evaluation section 32d extracts event information for every applicable purchase event from the event information database 39 (S1002). For every extracted purchase event information, the processing of the following steps 1003 to 1009 is repeatedly executed.

In this loop, first of all, from the event information database 39, extracted is event information with the event type of “take-out” under any product unique ID same as the product unique ID being a target for one of the purchase events extracted one or more in step 1002 (S1004). At this time, extracted is take-out event information within a time back by the duration of customer's stay in the store after the time when the purchase event has occurred. When the applicable take-out event is plurally found, extracted is only the event information showing the latest date and time. That is, extracted at this time is event information about a take-out event for the product being the target of the purchase event. Note here that the time to be back, i.e., estimated duration of customer's stay in the store may be determined in advance, and may be set to the program storage section 33. The time to be back may be determined by a statistical calculation using the average time until a customer makes a payment after entering the store, for example.

Next, with referent to the event information database 39, the related product information number is acquired from the take-out event information extracted in step 1004 (S1005). That is, in this example, acquired is a number of the related product information corresponding to advertisement information displayed when a customer takes out the product being the target of the purchase event.

Thereafter, with reference to the related product information database 36, a plurality of product codes are acquired for the related product information number acquired in step 1005. Also, with reference to the product master database 35, acquired is the product code(s) of the product unique ID(s) of one or more of the products being the targets of the purchase event. Such acquisitions are made based on the product unique ID(s). Thus acquired product codes are then compared with each other, and the number of any same product code is counted (S1006). That is, in this example, a comparison is made between one or more product types purchased by a customer and a plurality of product types found in the advertisement information displayed to the customer when he or she takes out a product, thereby finding out how many of the product types found in the advertisement information are purchased by the customer.

Next, with reference to the evaluation point provision policy stored in the program storage section 33, derived is the value of the evaluation-made point for the advertisement information displayed when the customer takes out a product (S1007).

As shown in FIG. 9, the evaluation point provision policy includes a box for one-time purchasing range 331, and an evaluation-made point field 332. The box for one-time purchasing range 331 is segmented depending on how many of the information-provided products are purchased. The evaluation-made point field 332 is stored with the value of the evaluation-made point for every item in the one-time purchasing range 331. The one-time purchasing range includes a plurality of items of “purchasing all of information-provided products being two or more”, “purchasing all of information-provided products being one”, “purchasing a part of information-provided products”, and “no purchasing of information-provided products”. The advertisement evaluation section 33d determines to which item of the evaluation point provision policy the purchasing pattern with the purchase event fits, and acquires the value of the evaluation-made point predetermined for the item. Note that the bracketed item in FIG. 9 is for a case where related product information is extracted with respect to any product similar to the product under the product code acquired in step 502 because the number of corresponding related product information in step 504 of FIG. 9 is 0 as described above.

After finding the value of the evaluation-made point as such, the advertisement evaluation section 33d then sets a log number for storage into a log number field 4001 in the advertisement evaluation log database 40 of FIG. 5. The advertisement evaluation section 33d also stores an event number of any one of the purchase events acquired in step 1002 into a purchase event number field 4002, an event number of the take-out event acquired in step 1004 into a take-out event number field 4003, and the one-time purchasing range and the value of the evaluation-made point found in step 1007 into the one-time purchasing range field 4004 and the evaluation-made point field 4005, respectively (S1008).

After such a loop from steps 1003 to 1009 is through, the value of the evaluation-made point is counted for every related product information, and the values of the point stored in any corresponding field of the related product information database 36 are added with the value of the counted evaluation-made point for every related product information. The result is then stored in any applicable field (S1010), and this is the end of the advertisement information evaluation processing.

Note that, in step 1004, a search is made for the take-out event information under any same product unique ID. Alternatively, when a membership number is read at the time of product take-out and purchase, a search may be made for take-out event information under any same membership number.

In the advertisement information evaluation processing described above, an evaluation point is provided even when only a product taken out from a shelf is purchased. Alternatively, in such a case, no evaluation-made point or a negative point may be provided as the displayed advertisement information brings no effect. Also when a product taken out from a shelf is not even purchased, the value of the evaluation-made point for advertisement information displayed to the customer may be negative. As such, the evaluation point provision policy may be changed arbitrarily, or may be freely set by every store or by clothing label, for example.

As described in the foregoing, in the embodiment, when a customer takes out a product from a shelf, advertisement display is accordingly made for a plurality of products related to the taken-out product, thereby being able to encourage the customer to make purchase. Also in this embodiment, the advertisement information is evaluated based on which of a plurality of product types displayed to the customer as the advertisement information contributes to the purchasing so that the effects of the advertisement information can be evaluated quantitatively. Moreover, in this embodiment, when potential advertisement information is found plurally with respect to a take-out event, the result of evaluating as such is referred to for displaying highly-evaluated advertisement information, thereby being able to encourage the customer to make purchase to a further extent.

### Second Embodiment

Described next is a second embodiment of the product information provider system of the invention.

The product information provider system of the second embodiment is similar to that of the first embodiment of FIG. 1, and additionally includes a gate reader 64 equipped with an antenna 63, and a gate terminal 7 connected to the gate reader 64. Note that, in the below, exemplified is a case where the product information provider system of the embodiment is disposed in a food supermarket. Also in the below, any component similar to that in the first embodiment is not described twice.

In this embodiment, because target products are food items, the related product information indicates a combination of food items, i.e., recipe information. Using product codes each indicating a product type, the related product information may be represented by a combination of product codes. In this example, however, the related product information is represented by product category codes each indicating a product category, e.g., carrot, potato, and beef. That is, the field 372 in the related product information database 37 of FIG. 3 is stored with the product category codes. This is because, when target products are food items and when recipe information is displayed to a customer, as long as the products fit in the product categories registered in advance in the recipe information, even if product codes vary, e.g., due to different quantities or different producing regions, the products are recognized as material needed for the recipe. Note here that if product specification is desired at the level of product codes, e.g., producing regions or quantities, the product codes may be stored together. The product master database 35 is storing, for every product code indicating a product type, in addition to information such as product name, price, and product category, mapping information between product unique IDs and product category codes. This mapping information enables to indicate the relationship between the product unique IDs and the product categories.

The antenna 63 of the gate reader 64 is installed inside of a gate 6 disposed on a store aisle on a shopping floor. Using the gate reader 64 equipped with such an antenna 63, the IC tag 12 of the product 11 is read when the product passes the gate 6. When a customer passes the gate 6, the gate 6 reading the IC tag 12 of the product 11 carried around by the customer tells what kind of product the customer is intended to buy. The gate terminal 7 is disposed in the vicinity of the gate 6, and receives a result of reading by the gate reader 64. The gate terminal 7 then processes the reading result, and transmits the result to the product information management server 3 as gate-pass event information. As a result of transmission as such, when advertisement information comes in return from the product information management server 3, the information is displayed on the display of the gate terminal 7.

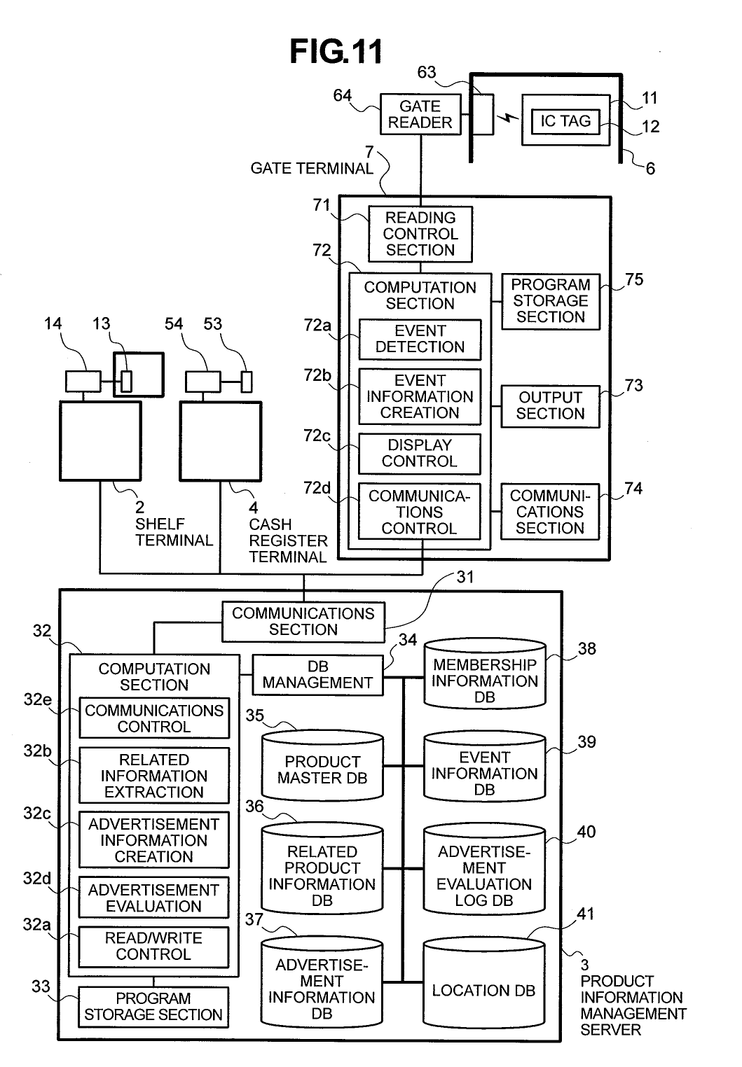

As shown in FIG. 11, the gate terminal 7 is configured to include a reader control section 71, a computation section 72, a communications section 74, an output section 73, and a program storage section 75. The reader control section 71 controls the driving of the gate reader 64, and the computation section 72 applies any predetermined processing to information being the reading result of the gate reader 64. The communication section 74 communicates with the product management server 3, and the output section 73 displays thereon advertisement information provided by the product management server 3. The program storage section 75 stores therein a program to be run by the computation section 72. The computation section 72 is configured to include an event detection section 72a, an event information creation section 72b, a display control section 72c, and a communications control section 72d. The event detection section 72a detects whether a product is being carried around, and to be more precise, whether a product has passed the gate. The event information creation section 72b creates event information in accordance with the event detected by the event detection section 72a. The display control section 72c controls display by the output section 73, and the communications control section 72d controls the communications section 74. The computation section 72 runs the program stored in the program storage section 75 so that the functions of the components 72a to 72d are implemented.

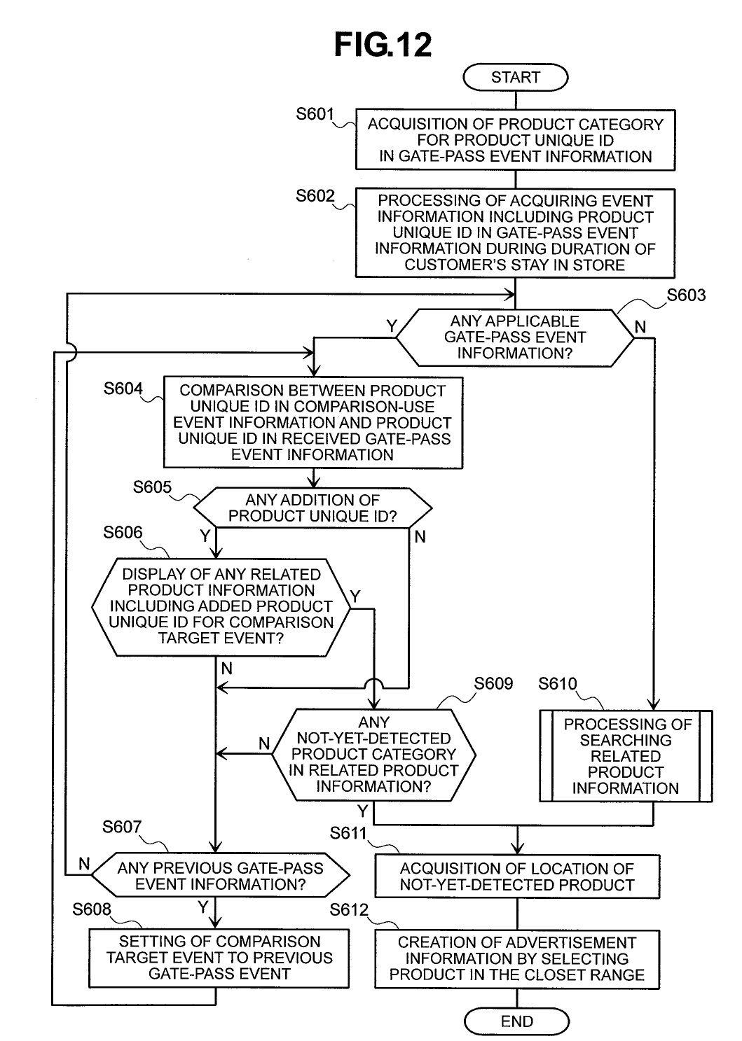

By referring to the flowcharts of FIGS. 6 and 12, described next is the operation of the product information provider system of this embodiment.

As shown in the flowchart of FIG. 6, the shelf terminal 2 and the cash register terminal 4 operate similarly to those in the first embodiment described above. The gate terminal 7 in this embodiment also operates, basically, similarly to the shelf terminal 2 and the cash register terminal 4. Similarly to the cash register terminal 4, the reader control section 71 of the gate terminal 7 continuously drives the gate reader 64, and at any arbitrary timing, makes the gate reader 64 read a product unique ID from the IC tag 12, and in some cases, read a membership number or others from a membership card (S10). By the product unique ID being read as such, the event detection section 74a of the gate terminal 7 acknowledges that the product 11 under this ID has passed the gate 6, i.e., a gate-pass event has occurred (S20).

After an event occurrence is detected as such, the event information creation section 72b of the gate terminal 7 creates event information (S30). This event information includes an event number, a product unique ID being the reading result, an event type (gate-pass), date and time when the event is detected, and the location of the event occurrence. When the membership number is read in step 10, this membership number is also included in the event information.

After the event information is generated as such, the event information is converted into any predetermined format of communications data by the communications control section 72d of the gate terminal 7, and the result is forwarded from the communications section 74 to the product information management server 3 (S40).

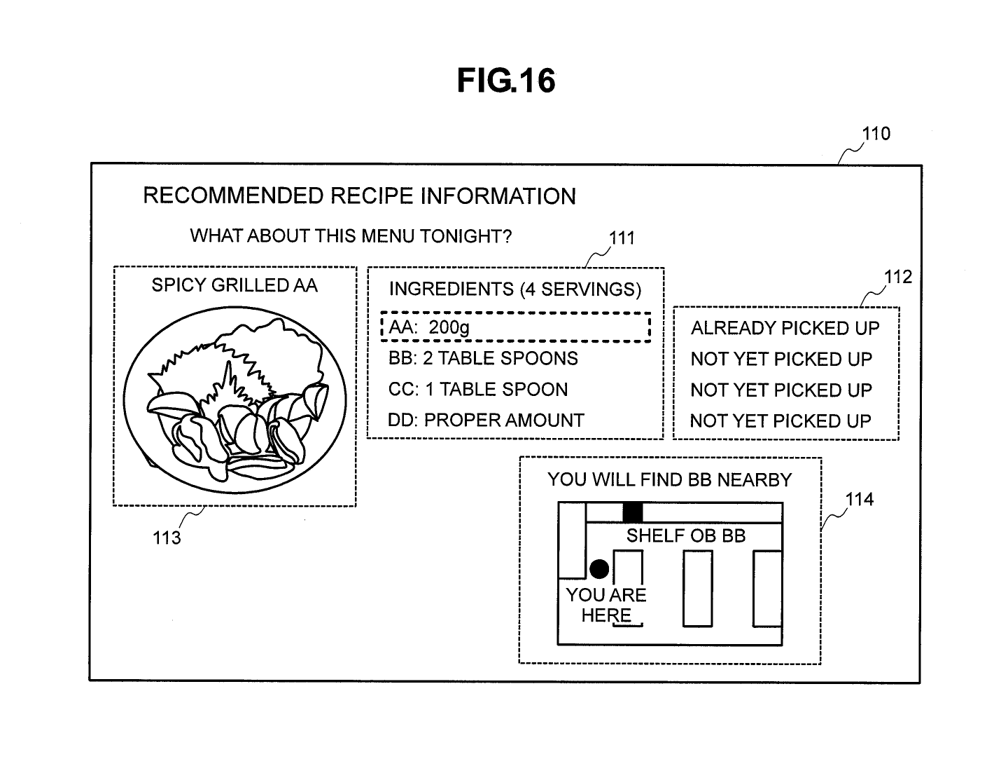

After the event information is forwarded to the product information management server 3, the gate terminal 7 is put into the waiting state for a return message from the product information management server 3. When receiving a return message (S50), the communications control section 72d determines whether the return message is including advertisement information. When no advertisement information is found, the procedure returns to step S10, and when any advertisement information is found, this advertisement information is forwarded to the display control section 72c for display by the output section 73 as shown in FIG. 16 (S60). After the advertisement information is displayed as such, the procedure returns to step S10.

On the other hand, when the product information management server 3 is in the state of waiting for event information to receive (S100), if event information comes from any of the components, i.e., the shelf terminal 2, the cash register terminal 4, and the gate terminal 7, the event information is accordingly received (S200). The product information management server 3 then analyzes the location found in the event information, and determines from which components of 2, 4, and 7, the event information is provided (S300).

When the event information is the one coming from the shelf terminal 2 or the cash register terminal 4, the product information management server 3 performs processing similar to that in the first embodiment (S500, 800, and 900), and the procedure returns to step 100. When the event information is the one coming from the gate terminal 7, the product information management server 3 processes the event information in a manner as will be described later (S600), and similarly to the case where the event information is provided by the other terminals 2 and 4, the procedure goes to step 800.

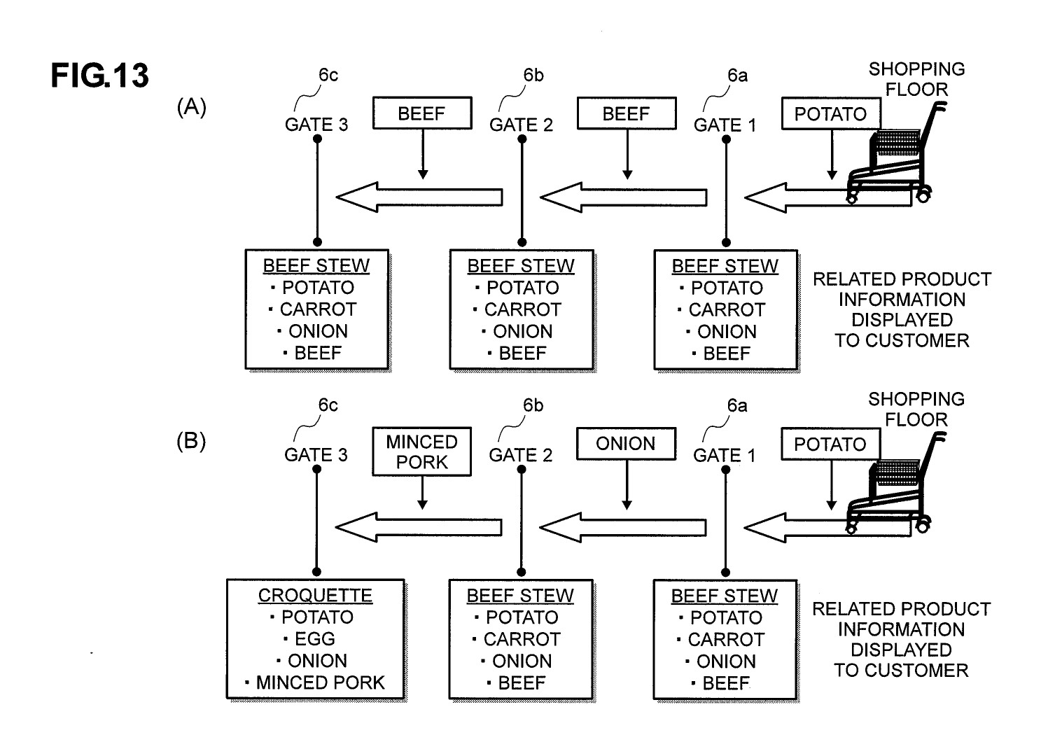

By referring to the flowchart of FIG. 12, described in detail next is processing (S600) to be performed by the product information management server 3 with respect to event information coming from the gate terminal 7. Note that, by referring to FIG. 13, the operation in the below will be described again with a specific example.

First of all, the related product information extraction section 32b of the product information management server 3 refers to the product master database 35, and acquires a product category code corresponding to the product unique ID found in the event information provided by the gate terminal 7 (S601). When the gate-pass event information includes two different product unique IDs under the same product category code corresponding thereto, this product category code is to be only acquired.

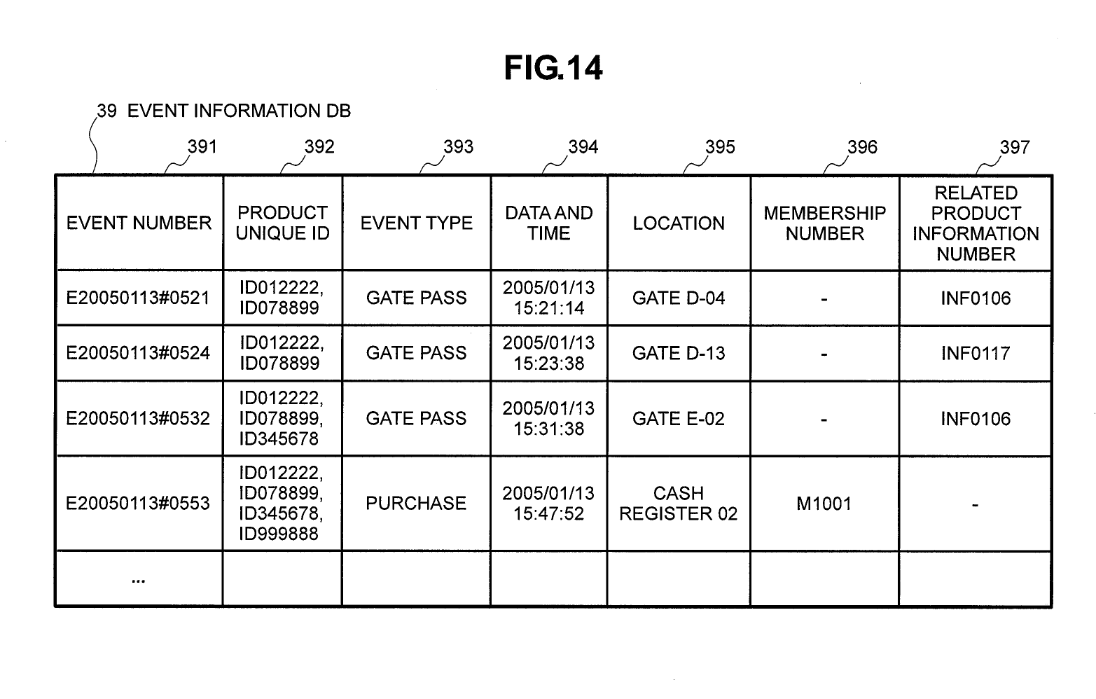

Next, the related product information extraction section 32b performs processing of acquiring any of the event information stored in the event information database 39, i.e., the event information under the product unique ID found in the gate-pass event information with the event type of “gate-pass”. The event occurrence time is within a time back only by a predetermined duration of customer's stay in the store after the product unique ID is detected (S602). Note here that FIG. 14 shows the data configuration of the event information database 39 in this embodiment. The related product information extraction section 32b determines whether the applicable event information is found in the event information database 39 (S603). When there is no such event information, a search is made for any new advertisement information in the procedure that will be described later (S610), and when there is such event information, a product unique ID found in event information provided for comparison use is compared with the product unique ID(s) found in the received gate-pass event information (S604). In this example, if there is no event information set as the comparison-use event information, the event information of step 602, if found, is set as the comparison-use event information. Note here that when the applicable event information is found plurally, any event information showing the latest date and time of the event detection is used as the comparison-use event information.

With such a comparison made between the product unique ID found in the comparison-use event information and the product unique ID(s) found in the received gate-pass event information, a determination is made whether any of the product unique IDs found in the received gate-pass event information is newly added compared with the product unique ID found in the comparison-use event information (S605). If there is no product unique ID being a new addition, the procedure immediately goes to step 607, and if there is such a product unique ID being a new addition, the event information database 39 is referred to for determining whether the related product information corresponding to the advertisement information displayed for the comparison target event includes the product category code of the product unique ID being a new addition (S606). When the related product information is not including a product of such a product unique ID being a new addition, a determination is made whether there is a previous gate-pass event for use as a potential comparison target event (S607). When there is no such previous gate-pass event as a potential comparison target event, the procedure returns to step 603, and a determination is made that there is no such applicable event information so that the procedure goes to step 610. When there is such a previous gate-pass event as a potential comparison target event, this gate-pass event is set to the comparison target event (S607), and the procedure returns to step 604.

In step 606, when the relative product information corresponding to the advertisement information provided for the comparison target event includes a product category code of the product unique ID being a new addition, a determination is made whether a plurality of product category codes found in the relative product information including any category code for a product not found in the received gate-pass event information, i.e., whether the product category codes in the related product information are all detected or not (S609). When there is no product category code not found in the received gate-pass event information, the procedure goes to the above-described step 607, and when there is such a product category code not found in the received gate-pass event information, the procedure goes to step 611. Moreover, also when the search processing is performed for any new advertisement information (S610), the procedure goes to step 611. That is, in step 609, when a customer has taken out only a part of the products in the related product information, for the purpose of encouraging the customer to purchase other products, performed is the processing of displaying the information about the products, i.e., the processing of displaying the advertisement information based on the same related product information (S611 and 612). On the other hand, when the customer has taken out all of the products in the related product information, for displaying advertisement information based on any other related product information, the procedure goes to step 610 after going through steps 607 and 603.

In step 611, the related product information extraction section 32b refers to the location database 41 for acquiring the related product information provided for the comparison target event, or location of one or more of the products. The product (s) here are those under the product category codes in the related product information acquired in step 610 but not included in the received gate-pass event information. The advertisement information creation section 32c selects any of the products located closest to the current position, i.e., the gate 6 being the source of the received gate-pass event information, and creates advertisement information based on the related product information (S612).

Also in this embodiment, similarly to the first embodiment, the advertisement information creation section 32c creates advertisement information by writing any necessary information into an advertisement screen template that is made ready in advance. With advertisement information 110 of FIG. 16, for example, the advertisement information creation section 32c acquires, from the advertisement information database 37, text data of the corresponding related product information number, i.e., in this example, product category names of the product category codes included in the related product information, and the quantity for use of the products under the product category names. Thus acquired data is written into an ingredient box 111 in the advertisement screen template. Moreover, with a correspondence to the position to which the product category names are written, the advertisement information creation section 32c writes the acquisition result, i.e., whether the products under the product category names are already acquired or not, into a box for user acquired result 112. As to the acquisition result, when the received gate-pass event information includes the product category code found in the related product information, it means that the product under the product category code is already acquired. When the received gate-pass event information includes no such product category code, it means that the product under the product category code is not yet acquired. The advertisement information creation section 32c also acquires, from the advertisement information database 37, image data of the corresponding related product information number, i.e., in this example, image data of dishes including every ingredient found in the related product information. Thus acquired image data is written into a dish image box 113 in the advertisement screen template. From the location database 41, the advertisement information creation section 32c then acquires map image data indicating the location of the product selected before, i.e., the product located closest to the gate 6 being the source of the received gate-pass event information, and map image data indicating the location of the information-source gate 6. Thus acquired image data are overlaid one on the other, and the result is written into a map box 114 in the advertisement screen template. At this time, in the map image data indicating the location of the information-source gate 6, the position of the information-source gate 6 is displayed as a current position.

Note here that the location database 41 is stored with, together with the location information (map image data) on a product category code basis, an antenna ID equipped to the gate 6 closest to the product corresponding to the product category code. Based on this information, the advertisement information creation section 32c selects any of the products closest to the information-source gate 6 of the received gate-pass event information.

Once the advertisement information is created (S612), the event information processing of the gate terminal 7 (S600) is ended, and thereafter, similarly to the first embodiment, as shown in the flowchart of FIG. 6, the event information entry processing (S800) is performed. In the return message creation processing (S900), the advertisement information created in the event information processing (S600) is included in a return message, and the resulting return message is forwarded to the gate terminal 7.

Next, the event information processing (S600) described above is again described with FIG. 13 example this time.

FIG. 13A shows a case where a customer tosses a sack of potatoes into his or her shopping cart in front of a first gate 6a, and then passes by a first gate 6a. The customer then tosses a pack of beef into his or her shopping cart, and passes by a second gate 6b. The customer then tosses a sack of onions into his or her shopping cart, and then passes by a third gate 6c.

In such a case, the gate terminal 7 of the third gate 6c detects that the products, i.e., potatoes, beef, and onions, have passed the gate so that the gate-pass event information coming from the gate terminal 7 includes product unique IDs of the potatoes, beef, and onions. Therefore, in step 601, the related product information extraction section 32b of the product management server 3 acquires product category codes of potatoes, beef, and onions, respectively.

The related product information extraction section 32b acquires, in step 602, gate-pass event information indicating that the beef and potatoes have passed the second gate 6b, and gate-pass event information indicating that the potatoes have passed the first gate 6a.

In this case, the related product information extraction section 32b determines in step 603 that there is any applicable event information, and the procedure goes to step 604. In step 604, from the gate-pass event information acquired in step 602, any gate-pass event information showing the latest event detection date and time, i.e., gate-pass event information about the second gate 6b, is selected for use as comparison-use event information. The related product information extraction section 32b then compares the products found in the comparison-use event information with the products found in the gate-pass event information received in step 601.

In this example, the products found in the gate-pass event information received in step 601 show an addition of onions compared with the products in the comparison-use event information. In step 604, it is thus determined that there is a new addition of product, and the procedure goes to step 606. In step 606, a determination is made whether the product being the addition is included in the related product information corresponding to the advertisement information provided for the comparison target event. Exemplified here is a case where the advertisement information displayed to a customer is recipe information about beef stew for the gate-pass event of the second gate 6b, i.e., comparison target event, and the ingredients for the beef stew include potato, carrot, onion, and beef. That is, in this case, the related product information for use as a basis of the advertisement information is assumed as including product category codes of potato, carrot, onion, and beef. If this is the case, because the addition of product (onion) is included in the related product information corresponding to the advertisement information provided for the comparison target event, the determination made in step 606 is Yes, and the procedure thus goes to step 609.

In step 609, a determination is made for the products in the related product information displayed in response to the gate-pass event of the second gate 6b, i.e., comparison target event, i.e., whether there is any product not included in the gate-pass event information received in step 601. That is, the determination is about whether the products in the displayed related product information are all detected or not. In this example, the related product information for the gate-pass event of the second gate 6b includes potato, carrot, onion, and beef, and the gate-pass event information received in step 601 only includes potato, beef, and onion. Therefore, it is determined that not all products in the gate-pass event information received in step 601, i.e., there is not-yet-detected product (carrot), and the procedure thus goes to step 611.

In step 611, the related product information extraction section 32b refers to the location database 41 for acquiring the location of any of the products included in the related product information displayed in response to the comparison target event but not found in the gate-pass event information received in step 601, i.e., carrot. In step 612, the advertisement information creation section 32c creates advertisement information based on this related product information. This advertisement information indicates the ingredients of beef stew, i.e., potato, carrot, onion, and beef, found in the related product information, and includes an in-store map indicating the customer's current position (the third gate 6c), and the location of carrots.

FIG. 13B shows a case where a customer tosses a sack of potatoes into his or her shopping cart in front of the first gate 6a, and then passes by the first gate 6a. The customer then tosses a sack of onions into his or her shopping cart, and passes by the second gate 6b . The customer then tosses a pack of minced pork into his or her shopping cart, and then passes by the third gate 6c.

In such a case, the gate terminal 7 of the third gate 6c detects that the products, i.e., potatoes, onions, and minced pork have passed the gate so that the gate-pass event information coming from the gate terminal 7 includes product unique IDs of the potatoes, onions, and minced pork. Therefore, in step 601, the related product information extraction section 32b of the product management server 3 acquires product category codes of potatoes, onions, and minced pork, respectively.

The related product information extraction section 32b acquires, in step 602, gate-pass event information indicating that the onions and the potatoes have passed the second gate 6b, and gate-pass event information indicating that the potatoes have passed the first gate 6a.

In this case, the related product information extraction section 32b determines in step 603 that there is any applicable event information, and the procedure goes to step 604. In step 604, from the gate-pass event information acquired in step 602, any gate-pass event information showing the latest event detection date and time, i.e., gate-pass event information about the second gate 6b, is selected for use as comparison-use event information. The related product information extraction section 32b then compares the products found in the comparison-use event information with the products found in the gate-pass event information received in step 601.

In this example, the products found in the gate-pass event information received in step 601 show an addition of minced pork compared with the products in the comparison-use event information. In step 604, it is thus determined that there is a new addition of product, and the procedure goes to step 606. In step 606, a determination is made whether the product being the addition is included in the related product information corresponding to the advertisement information displayed for the comparison target event. Exemplified here is a case where the advertisement information displayed to a customer is recipe information about beef stew for the gate-pass event of the second gate 6b, i.e., comparison target event, and the ingredients for the beef stew include potato, carrot, onion, and beef. That is, in this case, the related product information for use as a basis of the advertisement information is assumed as including product category codes of potato, carrot, onion, and beef. If this is the case, because the addition of product (minced pork) is not included in the related product information corresponding to the advertisement information provided for the comparison target event, the determination made in step 606 is No, and the procedure thus goes to step 607.

In step 607, a determination is made whether there is a previous gate-pass event as a potential comparison target event. Because there is a gate-pass event for the first gate 6a in this case, a determination is made that there is a previous gate-pass event, and thus the procedure goes to step 607. In this step 607, the previous gate-pass event, i.e., the gate-pass event for the first gate 6a, is set for use as the comparison target event, and the procedure returns to step 604.

As such, even when the gate-pass event for the first gate 6a is set for use as the comparison target event, similarly to the case described above, the procedure goes to step 607 after going through steps 605 and 606. In this step 607, a determination is made that there is no previous gate-pass event for use as a potential comparison target event, and the procedure returns to step 603. In this step 603, it is determined that there is no applicable event information, and the search processing is then performed in step 610 for the related product information. Exemplified here is a case where any related product information including ingredients needed for coquette is found, and thus found related product information includes potato, egg, onion, and minced pork.

In this case, the related product information extraction section 32b refers to the location database 41 in step 611 for acquiring the location of any of the products included in the related product information acquired in step 610 but not found in the gate-pass event information received in step 601, i.e., egg. In step 612, the advertisement information creation section 32c creates advertisement information based on this related product information. This advertisement information indicates the ingredients of coquette, i.e., potato, egg, onion, and minced pork, found in the related product information, and includes an in-store map indicating the customer's current position (the third gate 6c), and the location of eggs.

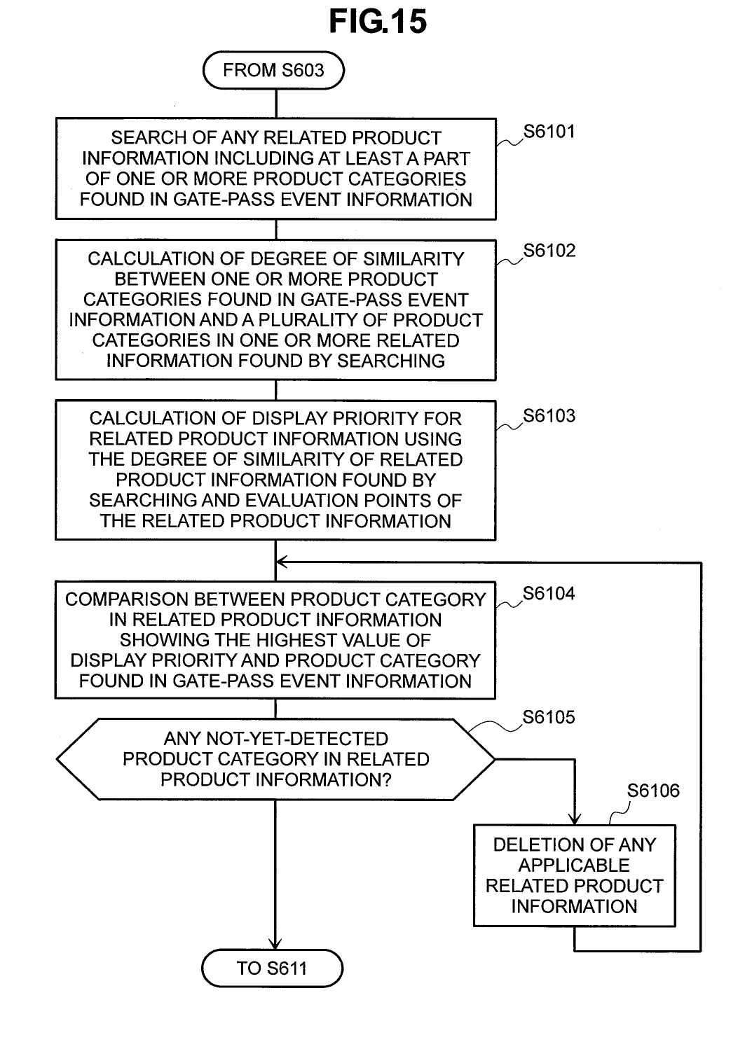

By referring to the flowchart of FIG. 15, described in detail next is the processing by the product information management server 3 with respect to related product information (S610).

First of all, the related product information extraction section 32b searches the related product information database 36 for the related product information including at least a part of one or more of the product category codes fond in the gate-pass event information received in step 601 described above (S6101). In this case, when the received gate-pass event information includes a plurality of product category codes, this may result in a difficulty in finding the related product information. In consideration thereof, a search is made for any related product including a part of the products found in the received gate-pass event information. In this case, a search engine applied with the similar pattern extraction technique may be used, e.g., even if product categories do not show a complete matching, any similar product category may be used for a search.

Thereafter, the related product information extraction section 32b calculates, using a search engine or others, the degree of similarity between one or more of the product category codes found in the gate-pass event information received in step 601, and a plurality of product category codes found in one or more of the related information being the search result of step 6101. Using the resulting similarities, a list of the degrees of similarity is created for the respective related product information (S6102). Note here that this list may include only the related product information showing the high degrees of similarity.

The related product information extraction section 32b then calculates a value ford is play priority for the respective related product information using the degree of similarity for the respective related product information, and a value of the cumulative evaluation point for the advertisement information corresponding to each of the related product information. Using the resulting value of the display priority, a list of the display priorities is created for the respective related product information (S6103). For calculation of such display priority, weight assignment is performed to the degree of similarity of any one of the related product information, and to the value of the cumulative evaluation point of the advertisement information corresponding thereto, for example. The results of weight assignment are added together, and the addition result is used as the display priority for the related product information. Any data needed for calculating the display priority, e.g., multiplication weight for parameters, is stored in advance in the program storage section 33.

Next, a comparison is made between a plurality of product category codes found in the related product information showing the highest value of display priority among others through with the calculation of display priority, and one or more of the product category codes found in the gate-pass event information received in step 601 (S6104). As to the product category codes found in the related product information, a determination is then made whether any one or more of the product category codes are not found in the gate-pass event information, i.e., whether there is any not-yet-detected product category code (S6105). When there is no not-yet-detected product category code, the corresponding related product information is deleted from the list of display priorities (S6106), and the procedure returns to step 6104. This is because there is no point in displaying the advertisement information based on the related product information acquired in step 6104. When there is any not-yet-detected product category code, this is set for use as the related product information, and this is the end of the related product information detection processing (S610). This is because there needs to display the advertisement information based on the related product information acquired in step 6104.

As such, in the embodiment, the related product information search processing (S610) enables to estimate a customer's expecting combination of products from his or her shopping cart, and provide the customer with information about any product not yet put in the shopping cart. This accordingly enables to encourage the customer to buy a plurality of products all at once. Moreover, in this embodiment, among the products not yet in the customer's shopping cart, any product located closest to the customer's current position is displayed in position so that the customer can do his or her shopping with good efficiency.

In the event information processing (S600) of FIG. 12, acquisition of the gate-pass event information is performed with a time back by an estimated duration of customer's stay in the store in step 602. Alternatively, when there are a large number of event information, or when the calculation time is required to be shorter, the time to be back may be freely set as required, e.g., a shorter time is set.

Also in the event information processing (S600), in addition to the processes of FIG. 12, a membership card may be read at the gate 6 together with the products 11. If this is the case, the purchasing history in the member information database 38 may be searched to find any recently-purchased products, and related product information including both thus found product(s) and the products 11 read at the gate 6 may be displayed. Alternatively, the event information database 39 may be searched for the purchasing history of any other members showing similar attribute to the customer's, and related product information created based on thus found purchasing history may be displayed to the customer.

### Third Embodiment

Described next is a third embodiment of the product information provider system of the invention.

The product information provider system of the third embodiment is similar to that of the first embodiment of FIG. 1, and additionally includes a gate reader 84 equipped with an antenna 83, and a cart terminal 9 connected to the gate reader 84. In other words, as alternatives to the gate reader 64 and the gate terminal 7 of the second embodiment, the cart reader 84 and the cart terminal 9 are provided. In the below, any component similar to that in the first embodiment is not described twice.

The cart reader 84 and the cart terminal 9 are equipped to a shopping cart (hereinafter, simply referred to as cart) 8. The basket portion of the cart 8 is equipped with the antenna 83 of the cart reader 84. Using the cart reader 84 equipped with such an antenna 83, the IC tag 12 of the product 11 is read when the product is put into the basket portion of the cart 8. Reading the IC tag 12 of the product 11 in the basket using the cart reader 84 tells which product the customer is intended to buy. The cart terminal 9 receives a result of reading by the cart reader 84. The cart terminal 9 then processes the reading result, and transmits the result to the product information management server 3 as in-basket event information. As a result of transmission as such, when advertisement information comes in return from the product information management server 3, the information is displayed on the display of the cart terminal 9. For attachment to the cart 8, this cart terminal 9 is configured by a small-sized computer, e.g., tablet computer. This computer is battery-operated for preventing any possible trouble even if the cart 8 moves freely in the store, and is provided with wireless LAN capability for wireless communications with the product management server 3. Alternatively, the antenna 83 of the cart reader 84 may be placed at the bottom surface of the basket for reading of every product unique ID, or may be placed at the upper side of the basket for reading of only product unique IDs putting in and out of the basket.

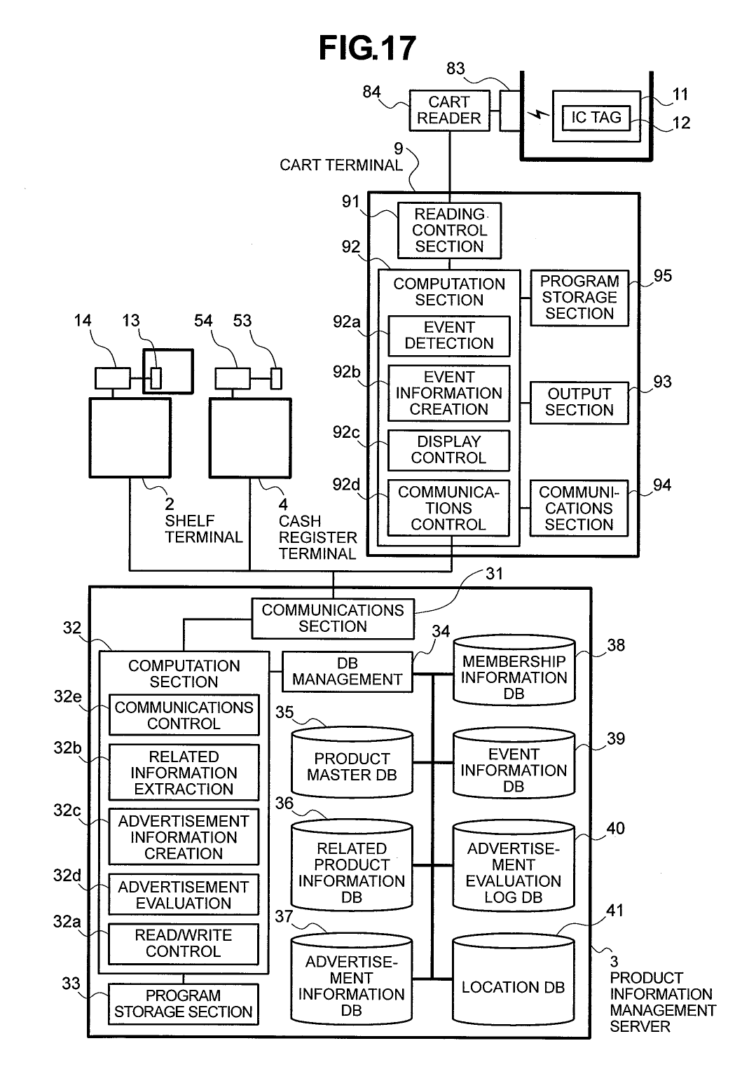

As shown in FIG. 17, similarly to the gate terminal 7 of the second embodiment, the cart terminal 9 is configured to include a reader control section 91, a computation section 92, a communications section 94, an output section 93, and a program storage section 95. The reader control section 91 controls the driving of the cart reader 84, and the computation section 92 applies any predetermined processing to information being the reading result of the cart reader 84. The communication section 94 communicates with the product management server 3, and the output section 93 displays thereon advertisement information provided by the product management server 3. The program storage section 95 stores therein a program to be run by the computation section 92. The computation section 92 is configured to include an event detection section 92a, an event information creation section 92b, a display control section 92c, and a communications control section 92d. The event detection section 92a detects whether a product is being put in or out of the basket of the cart 8. The event information creation section 92b creates event information in accordance with the event detected by the event detection section 92a. The display control section 92c controls display by the output section 93, and the communications control section 92d controls the communications section 94. The computation section 92 runs the program stored in the program storage section 95 so that the functions of the components 92a to 92d are implemented.

Described next is the operation of the product information provider system of this embodiment.

As shown in the flowchart of FIG. 6, the shelf terminal 2 and the cash register terminal 4 operate similarly to those in the first embodiment described above. The cart terminal 9 in this embodiment also operates, basically, similarly to the shelf terminal 2 and the cash register terminal 4. Similarly to the shelf terminal 2, the reader control section 91 of the cart terminal 9 drives the cart reader 84 at regular intervals, and also at regular intervals, makes the cart reader 84 read a product unique ID from the IC tag 12 in the basket of the cart 8, and in some cases, read a membership number or others from a membership card (S10). By the product unique ID being read as such, the event detection section 94a of the cart terminal 9 acknowledges that the product 11 under this ID has put in the basket of the cart 8, i.e., an in-basket event has occurred. After such reading of the product unique ID from the IC tag 12, when the product unique ID becomes not available for reading, the event detection section 94a acknowledges that the product 11 under this ID has taken out from the basket of the cart 8, i.e., an out-basket event has occurred (S20).

After an event occurrence is detected as such, the event information creation section 92b of the cart terminal 9 creates event information (S30). This event information includes an event number, a product unique ID being a reading result, an event type (in-basket and out-basket), date and time when the event is detected, and the location of the event occurrence. As to the location of this event occurrence, the event information also indicates that the event has occurred in a cart, and includes the ID of the cart. When the membership number is read in step 10, this membership number is also included in the event information.

After the event information is generated as such, the event information is converted into any predetermined format of communications data by the communications control section 92d of the cart terminal 9, and the result is forwarded from the communications section 94 to the product information management server 3 (S40).

After the event information is forwarded to the product information management server 3, the cart terminal 9 is put into the waiting state for a return message from the product information management server 3. When receiving a return message (S50), the communications control section 92d determines whether the return message is including advertisement information. When no advertisement information is found, the procedure returns to step S10, and when any advertisement information is found, this advertisement information is forwarded to the display control section 92c for display by the output section 73 (S60). After the advertisement information is displayed with the cart terminal 9 as such, the procedure returns to step 10.

On the other hand, when the product information management server 3 is in the state of waiting for event information (S100), if event information comes from any of the components, i.e., the shelf terminal 2, the cash register terminal 4, and the cart terminal 9, the event information is accordingly received (S200). The product information management server 3 then analyzes the location found in the event information, and determines from which components of 2, 4, and 9, the event information is provided (S300).

When the event information is the one coming from the shelf terminal 2 or the cash register terminal 4, the product information management server 3 performs processing similar to that in the first embodiment (S500, 800, and 900), and the procedure returns to step 100. When the event information is the one coming from the cart terminal 9, the product information management server 3 processes the event information provided by the cart terminal 9 (S700), and similarly to the case where the event information is provided by the other terminals 2 and 4, the procedure goes to step 800.

The processing of event information provided by the cart terminal 9 (S700) is substantially similar to the processing of event information (S600) provided by the gate terminal 7 in the second embodiment described by referring to FIGS. 12 and 15. That is, when detected is event information including the location being in the cart 8, any appropriate related product information may be searched using the product 11 found in the basket of the cart 8, and the found information is displayed on the display of the cart terminal 9. Note that, in the third embodiment, for the aim of fining any closest product in step 611 in the flowchart of FIG. 12, the location of the product 11 put in or out of the basket is set as the current position of the cart 8, and the product closest in location thereto is selected.

As such, in the third embodiment, as described above, the cart reader 84 and the cart terminal 9 are provided as alternatives to the gate reader 64 and the gate terminal 7 of the second embodiment, and the system operation in this embodiment is substantially similar to that of the second embodiment, thereby achieving effects similar to the second embodiment.

In the third embodiment, preferably, only for an in-basket event, advertisement information based on the related product information may be displayed, and for an out-basket event, no advertisement information based on the related product information may be displayed, and entry of event information may be only performed. Exemplified above is the case that the cart reader 84 and the cart terminal 9 are provided as alternatives to the gate reader 64 and the gate terminal 7 of the second embodiment. This is surely not restrictive, and the gate reader 64 and the gate terminal 7 of the second embodiment may be also provided. This is because customers do not always use the carts 8, and even if so, the system can deal with such a possible case. With this being the case, if a customer uses the cart 8, the system may handle both an in-basket event and a gate-pass event although these are substantially the same events. Thus, at the time of display of advertisement information in response to a gate-pass event, advertisement information displayed for an in-basket may not be preferably displayed.

Also in the second and third embodiments, the advertisement information displayed by the gate terminal 7 and the cart terminal 9 may be subjected to the advertisement information evaluation processing of the first embodiment described by referring to FIG. 8. As such, when the advertisement information displayed using the gate terminal 7 and the cart terminal 9 is also subjected to the advertisement information evaluation processing, in the second and third embodiments, the shelf terminal 2 and the shelf reader 14 may not necessarily be provided.

As such, while the embodiments of the invention have been described in detail, the foregoing description is in all aspects illustrative and not restrictive. It is understood that numerous other modifications and variations can be devised without departing from the scope of the invention. For example, the target products in the above embodiments are clothing or food, and the invention is surely applicable to various other many product types, e.g., accessory, daily necessities, consumer items, book, media such as music and movie, household electrical appliance, electronic equipment, and sports and outdoor goods.

Moreover, in the above embodiments, the IC tag 12 for attachment to a product is storing only a product unique ID. This is surely not restrictive, and the IC tag 12 may store therein not only a product unique ID but also a product code and a product category code. If this is the case, by reading such codes, the product information management server 3 becomes able to keep track of the product codes and the product category codes without using the product master database 35.

What is claimed is:

1. A product information provider system that offers information about a plurality of products through wireless communications with a wireless communication tag attached to each of the products and stored with an identifier assigned each of the products, the system comprising:
a reader that reads the identifiers of the products through wireless communications with the wireless communications tags attached to the products being disposed at a product space;
event detection means for detecting whether any of the products is taken out from the product space in accordance with a reading result of the reader;
related information storage means being stored with a plurality pieces of related product information each including a combination of a plurality of product types that are considered preferable to purchase together and/or advertise together;
related information extraction means for extracting, when a take-out event is detected for any of the products by the event detection means, any of the related product information stored in the related information storage means including the product types for the product;
advertisement information creation means for creating advertisement information for the product types found in the related product information extracted by the related information extraction means using previously-stored advertisement data; and
advertisement output means for outputting the advertisement information created by the advertisement information creation means.

2. A product information provider system that offers information about a plurality of products through wireless communications with a wireless communication tag attached to each of the products and stored with an identifier assigned each of the products, the system comprising:
a reader that reads the identifier of any of the products being carried around on a shopping floor through wireless communications with the wireless communications tag attached to the product;
event detection means for detecting a product type of the product being carried around in accordance with a reading result of the reader;
related information storage means being stored with a plurality pieces of related product information each including a combination of a plurality of product types that are considered preferable to purchase together and/or advertise together;
related information extraction means for extracting, when a carry-around event is detected for the product by the event detection means, any of the related product information stored in the related information storage means including the product type for the product;
advertisement information creation means for creating advertisement information for the product types found in the related product information extracted by the related information extraction means using previously-stored advertisement data; and
advertisement output means for outputting the advertisement information created by the advertisement information creation means.

3. The product information provider system according to claim 2, wherein
the reader and the advertisement output means are disposed on a store aisle of the shopping floor.

4. The product information provider system according to claim 2, wherein
the reader and the advertisement output means are equipped to a shopping cart or a shopping basket.

5. The product information provider system according to claim 1, wherein
the advertisement information creation means
creates the advertisement information including shopping-floor position information about at least one of the product types found in the related product information extracted by the related information extraction means using, as the previously-stored advertisement data, data indicating a position on a shopping floor of at least one of the product types not including the product type related to the event detected by the event detection means.

6. The product information provider system according to claim 1, further comprising:
event information storage means for storing, with a correlation, the identifier of the product through with event detection by the event detection means and the related product information extracted by the related information extraction means in accordance with an event detection result for the product;
a payment reader that reads, at a time of payment, the identifier of one or more of the products whatever purchased through wireless communications with the wireless communications tag(s) attached to the product(s); and
advertisement information evaluation means for searching the identifiers stored in the event information storage means to find the identifier(s) of the product(s) read by the payment reader, extracting the related product information related to the identifier(s), comparing the product types found in the related product information and the product type of one or more of the identifiers read by the payment reader, and evaluating the advertisement information about the related product information using a predetermined evaluation technique.

7. The product information provider system according to claim 6, wherein
the predetermined evaluation technique gives a higher evaluation score when the product types found in the related product information share a larger number of the same product type of one or more of the identifiers read by the payment reader.

8. The product information provider system according to claim 6, further comprising
evaluation result storage means for storing a result of evaluating the advertisement information by the advertisement information evaluation means with a correlation to the related product information about the advertisement information, wherein
after the event detection for the product, at a time of extracting any of the related product information stored in the related information storage means including the product type of the product, when finding and extracting plurally the related product information including the product type, the related information extraction means refers to the evaluation result storage means to extract, from the plurality pieces of extracted related product information, in order of high evaluation scores, the related product information as many as the advertisement information that is previously made ready for simultaneous output by the advertisement output means.

9. The product information provider system according to claim 1, further comprising
event information storage means for storing, with a correlation, the identifier of the product for which the take-out event is detected by the event detection means, a time when the take-out event is detected for the product, and the related product information corresponding to the advertisement information forwarded with respect to the take-out event of the product, wherein
after the take-out event is detected for the product, at a time of extracting any of the related product information stored in the related information storage means including the product type of the product, when finding and extracting plurally the related product information including the product type, within a time back by a predetermined length of time after when the take-out event is detected, from the identifiers of the products stored in the event information storage means, the related information extraction means extracts any of the identifiers of the products under the same product type as that of the product for which the take-out event is detected, and excludes any of the related product information corresponding to the identifier from the related product information being the extraction result.

10. A product information provider method of offering information about a plurality of products through wireless communications with a wireless communication tag attached to each of the products and stored with an identifier assigned each of the products, the method comprising:
a read step of reading, using a reader, the identifiers of the products through wireless communications with the wireless communications tags attached to the products being disposed at a product space;
an event detection step of detecting whether any of the products is taken out from the product space in accordance with a reading result of the reader;
a related information extraction step of extracting, when a take-out event is detected for any of the products in the event detection step, from a related information storage area storing therein a plurality of pieces of related product information each including a combination of a plurality of product types that are considered preferable to purchase together and/or advertise together, any of the related product information including a product type of the product;
an advertisement information creation step of creating advertisement information for the product types found in the related product information extracted in the related information extraction step using previously-stored advertisement data; and
an advertisement output step of outputting the advertisement information created in the advertisement information creation step in the vicinity of a place where the take-out event is occurred.

11. A product information provider method of offering information about a plurality of products through wireless communications with a wireless communication tag attached to each of the products and stored with an identifier assigned each of the products, the method comprising:
a read step of reading, using a reader, the identifier of any of the products being carried around on a shopping floor through wireless communications with the wireless communications tag attached to the product;
an event detection step of detecting a product type of the product being carried around in accordance with a reading result of the reader;
a related information extraction step of extracting, when a carry-around event is detected for the product in the event detection step, from a related information storage area storing therein a plurality pieces of related product information each including a combination of a plurality of product types that are considered preferable to purchase together and/or advertise together, any of the related product information including the product type of the product;
an advertisement information creation step of creating advertisement information for the product types found in the related product information extracted in the related information extraction step using previously-stored advertisement data; and
an advertisement output step of outputting, by output means, the advertisement information created in the advertisement information creation step in the vicinity of a place where the carry-around event is occurred.

12. The product information provider method according to claim 11, wherein
the reader and the output means are disposed on a store aisle of the shopping floor.

13. The product information provider method according to claim 11, wherein
the reader and the output means are equipped to a shopping cart or a shopping basket.

14. The product information provider method according to claim 10, wherein
the advertisement information creation step
creates the advertisement information including shopping-floor position information about at least one of the product types found in the related product information extracted in the related information extraction step using, as the previously-stored advertisement data, data indicating a position on a shopping floor of at least one of the product types not including the product type related to the event detected in the event detection step.

15. The product information provider method according to claim 10, further comprising:
an event information storage step of storing, in an event information storage area, with a correlation, the identifier of the product through with event detection in the event detection step and the related product information extracted in the related information extraction step in accordance with an event detection result for the product;
a payment read step of reading, using a payment reader, at a time of payment, the identifier of one or more of the products whatever purchased through wireless communications with the wireless communications tag(s) attached to the product(s); and
an advertisement information evaluation step of searching the identifiers stored in the event information storage area to find the identifier(s) of the product(s) read by the payment reader, extracting the related product information related to the identifier(s), comparing the product types found in the related product information and the product type of one or more of the identifiers read by the payment reader, and evaluating the advertisement information about the related product information using a predetermined evaluation technique.

16. The product information provider method according to claim 15, wherein
the predetermined evaluation technique gives a higher evaluation score when the product types found in the related product information share a larger number of the same product type of one or more of the identifiers read by the payment reader.

17. The product information provider method according to claim 15, further comprising
an evaluation result storage step of storing, in an evaluation result storage area, a result of evaluating the advertisement information in the advertisement information evaluation step with a correlation to the related product information about the advertisement information, wherein
after the event detection for the product, at a time of extracting any of the related product information stored in the related information storage area including the product type of the product, when finding and extracting plurally the related product information including the product type, the related information extraction step refers to the evaluation result storage area to extract, from the plurality pieces of extracted related product information, in order of high evaluation scores, the related product information as many as the advertisement information that is previously made ready for simultaneous output in the advertisement output step.

18. The product information provider method according to claim 10, further comprising
an event information storage step of storing, in an event information storage area, with a correlation, the identifier of the product for which the take-out event is detected in the event detection step, a time when the take-out event is detected for the product, and the related product information corresponding to the advertisement information forwarded with respect to the take-out event of the product, wherein
after the take-out event is detected for the product, at a time of extracting any of the related product information stored in the related information storage area including the product type of the product, when finding and extracting plurally the related product information including the product type, within a time back by a predetermined length of time after when the take-out event is detected, from the identifiers of the products stored in the event information storage area, the related information extraction step extracts any of the identifiers of the products under the same product type as that of the product for which the take-out event is detected, and exclude any of the related product information corresponding to the identifier from the related product information being the extraction result.
